(19) United States
(12) Patent Application Publication
(10) Pub. No.: US 2025/0000014 A1
(43) Pub. Date: Jan. 2, 2025

(54) Systems And Methods For Selecting Seed Products For Planting In Growing Spaces

(71) Applicant: CLIMATE LLC, Saint Louis, MO (US)

(72) Inventors: Charlie BEELER, Saint Louis, MO (US); Liaoliao CAO, Chesterfield, MO (US); Camila CASQUILHO, London (GB); Lingxiu DONG, Saint Louis, MO (US); LeAnna GUERIN, Saint Peters, MO (US); Michael IBERG, Wentzville, MO (US); Yixuan JI, Lebanon, NH (US); Dongming JIANG, Chesterfield, MO (US); Michael JOHNSON, Saint Louis, MO (US); Meserret KARACA, O'Fallon, MO (US); Minkyu KIM, Seattle, WA (US); Matthew LAU, Saint Louis, MO (US); Bing LIU, Chesterfield, MO (US); Niloy MUKHERJEE, Wentzville, MO (US); Martin NAVARRO, Pergamino (AR); Azadeh Sanayi OSTOVAR, Chesterfield, MO (US); Rodrigo REJAILI, São Paulo (BR); Matheus SALVADOR, São Paulo (BR); Durai SUNDARAMOORTHI, Saint Louis, MO (US); Bijan TASLIMI, Saint Louis, MO (US); Huong TRAN, Seattle, WA (US); Nathan VANDERKRAATS, Saint Louis, MO (US); Diana WINDEMUTH, Seattle, WA (US); Hong ZHANG, Snohomish, WA (US)

(21) Appl. No.: 18/755,470

(22) Filed: Jun. 26, 2024

Related U.S. Application Data
(60) Provisional application No. 63/523,633, filed on Jun. 27, 2023.

(51) Int. Cl. A01C 14/00; G06N 20/20; G06Q 10/04; G06Q 50/02

(52) U.S. Cl. CPC A01C 14/00; G06N 20/20; G06Q 10/04; G06Q 50/02

(57) ABSTRACT

Systems and methods for planting specified seed products in target growing spaces. An example method includes receiving a request for a planting recommendation related to seeding of a target growing space and, in response, determining, using one or more seed placement prediction models, a prediction output including a predicted yield for multiple seed products at the target growing space at each of one or more different weather conditions. The method also includes determining, using an optimization model, a seed planting recommendation output, based on at least the prediction output and at least one grower constraint parameter associated with the target growing space, where the seed planting recommendation output includes at least one of the multiple seed products, and then directing planting of the at least one of the multiple seed products at the target growing space based on the seed planting recommendation output.

### CROSS-REFERENCE TO RELATED APPLICATION

This application claims the benefit of, and priority to, U.S. Provisional Application No. 63/523,633, filed Jun. 27, 2023. The entire disclosure of the above application is incorporated herein by reference.

### FIELD

The present disclosure generally relates to systems and methods for planting specified seed products in growing spaces, and in particular, to systems and methods for use in selection of types of seed products for planting in the growing spaces based on predicted yield and variance for multiple seed products.

### BACKGROUND

This section provides background information related to the present disclosure which is not necessarily prior art.

It is known for seeds to be grown in fields for commercial purposes, whereby resulting plants, or parts thereof, are sold by the growers for business purposes. For example, soybeans may be grown by a grower in a field owned by the grower, and the soybeans grown and harvested from the field may then be sold. Similarly, in another example, corn may be grown by a grower in a field owned by the grower, and the corn grown and harvested from the field may then be sold. Consequently, growers often seek to plant particular seeds (e.g., corn versus soybeans, soybean seed type A versus soybean seed type B, etc.), based on specific aims of the growers, specific climate conditions (e.g., drought tolerance, etc.), and disease resistance. In addition, growers may also estimate future yield performance of different candidate crop types, in order to make decisions regarding which types of crop seeds to plant for a growing season.

### SUMMARY

This section provides a general summary of the disclosure and is not a comprehensive disclosure of its full scope or all of its features.

Example embodiments of the present disclosure generally relate to computer-implemented methods for use in determining types of seed products for planting in growing spaces and directing placement of such seed products in the growing spaces. In one example embodiment, a method for directing seed products to growing spaces generally includes: receiving, by a computing device, a request for a planting recommendation related to seeding of a target growing space, the request including seed product data and location data relating to the target growing space, the seed product data including multiple identifiers each associated with a different one of multiple seed products available for planting at the target growing space; accessing, by the computing device, one or more seed placement prediction models consistent with the location data; determining, by the computing device, using the one or more seed placement prediction models, a prediction output, based, at least, on the location data and on weather data, the prediction output including a predicted yield for the multiple seed products at each of one or more different weather conditions, seed densities, and/or planting dates; accessing, by the computing device, an optimization model consistent with the target growing space; determining, by the computing device, using the optimization model, a seed planting recommendation output, based on, at least, the prediction output and at least one grower constraint parameter associated with the target growing space, the seed planting recommendation output including at least one of the multiple seed products; and directing, by the computing device, planting of the at least one of the multiple seed products at the target growing space, based on the seed planting recommendation output.

Example embodiments of the present disclosure generally relate to systems for use in directing seed products to growing spaces. In one example embodiment, such a system generally includes at least one computing device configured to: receive a request for a planting recommendation related to seeding of a target growing space, the request including seed product data and location data relating to the target growing space, the seed product data including multiple identifiers each associated with a different one of multiple seed products available for planting at the target growing space; access one or more seed placement prediction models consistent with the location data; determine, using the one or more seed placement prediction models, a prediction output, based, at least, on the location data and on weather data, the prediction output including a predicted yield for the multiple seed products at each of one or more different weather conditions, seed densities, and/or planting dates; access an optimization model consistent with the target growing space; determine, using the optimization model, a seed planting recommendation output, based on at least the prediction output and at least one grower constraint parameter associated with the target growing space, the seed planting recommendation output including at least one of the multiple seed products; and direct planting of the at least one of the multiple seed products at the target growing space, based on the seed planting recommendation output.

Example embodiments of the present disclosure generally relate to non-transitory computer-readable storage media including executable instructions, which when executed by at least one processor in connection with directing seed products to growing spaces, cause the at least one processor to perform one or more of the operations recited above (and/or in the claims appended hereto).

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1-1A illustrate an example system for use in selecting types of seed products for planting in growing spaces based on predicted yield and variance for multiple seed products;

FIG. 2 illustrates an example method, that may be used and/or implemented in the system of FIG. 1, for selecting types of seed products for planting in growing spaces based on predicted yield and variance for multiple seed products;

FIGS. 3A-3B illustrate an example logical organization of sets of instructions in main memory of a computing device when an example application is loaded on the computing device for execution; and

FIG. 4 is a block diagram that illustrates a computing device (or computer system) upon which embodiments of the system of FIG. 1 and/or the method of FIG. 2 may be implemented.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Growers make decisions related to the planting, treatment, and harvesting of crops in fields, often with the aim of enhancing the performance of the crops in the fields. One example decision relates to what types of seeds to plant, based on different crop types, crop varieties, and seed products. In general, given the cost associated with the seeds and variable profits depending on the yield of the crops, the grower may decide to plant crop types and/or seed products that have a higher likelihood of increased crop yield (as compared to expected yields from other available crop types and/or seed products). However, likely yields of different crop types, crop varieties, and seed products, conventionally, are not predictable at desired levels of accuracy, or may be associated with specific risks. As such, growers' decisions related to selection of types and varieties of seeds to plant in a target field, in general, are susceptible to inaccuracy, potentially leading to a lower yield of the selected seed type as compared to other available seed types and varieties that were not planted, etc.

Uniquely, the systems and methods herein provide for selecting crop types and/or seed products to plant from multiple available seed types, based on seed placement predictions and further optimization for multiple candidate seed types.

In particular, crop yield data associated with growing spaces (e.g., fields, plots, etc.) in different locations is accessed and manipulated in one or more manners to provide data indicative of crop yields for various seed types, in the growing spaces and regions. The data is then used to train a seed placement prediction model such as, for example, a model that predicts both expected yield of each crop type and/or seed product and a potential variance of the yield based on one or more factors (e.g., such as soil data, genetic features, weather events, topographic information, seed density, planting date, etc.). The trained placement model is then employed, in connection with multiple candidate seed types, whereby a performance, based on the trained model, is defined for a target growing space, across, potentially, predicted variances and/or risk. Further, placement outputs may be provided to a trained model to recommend an optimized portfolio of seeds for multiple seed types, to be planted at the target growing space. Specifically, a portfolio optimization model may be trained to generate a seed planting recommendation output based on, for example, the placement output, predicted variances of the crop type and/or seed product yields, and grower constraints (e.g., preferred seeding rates, preferred relative maturity (RM) spread, preferred number of varieties in a planting range, preferred trait and brand mix, preferred product volume, etc.), agronomic/disease trait preference, field productivity, etc.

The recommendation is then issued or otherwise presented to the grower, whereby the grower is then permitted to rely on the recommendation for a decision (and, as desired, implement the decision in the growing space). In this manner, objective data-based criteria is employed to inform decisions related to selection of candidate crop types and/or seed products for planting in growing spaces, in lieu of subjective understandings (e.g., by the grower, etc.) about expected yields of various candidate crop types and/or seed products.

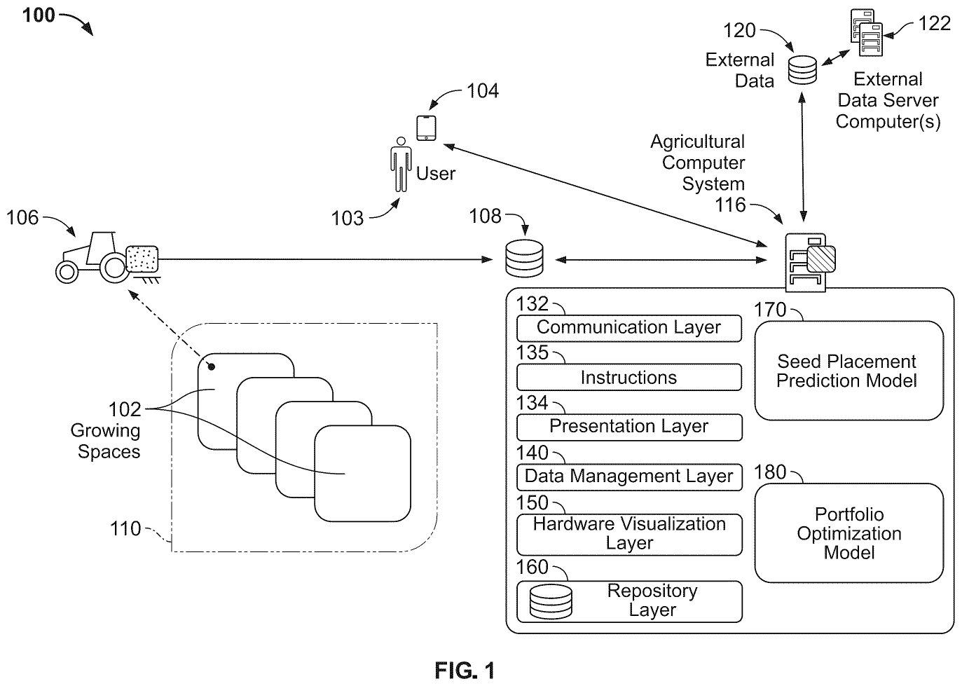

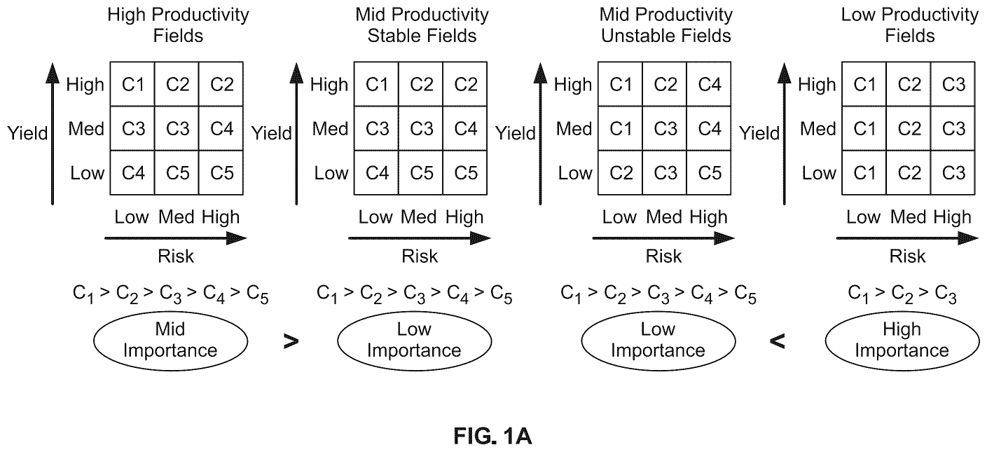

FIG. 1 illustrates an example system 100 in which one or more aspect(s) of the present disclosure may be implemented. Although the system 100 is presented in one arrangement, other embodiments may include the parts of the system 100 (or other parts) arranged otherwise depending on, for example, types of seeds/crops; available candidate seeds; types and/or locations of growing spaces, and/or privacy and/or data requirements; etc.

The system 100 generally includes various growing spaces 102 (e.g., fields plots, etc.), for example, associated with a user 103 (e.g., a grower, etc.). The growing spaces 102 are shown in solid lines. The growing spaces 102 may each include, without limitation, at least a portion of one or more fields (e.g., commercial fields, research/test fields, etc.), greenhouses, shade houses, nurseries, etc.

In the illustrated embodiment, the growing spaces 102 are included within a region 110. The region 110 may include and/or may be defined by postal codes, area codes, counties, a group of counties, a state, a group of states, territories, a group of territories, a country, a group of countries, or other geo-political boundaries or non-geo-political boundaries (e.g., a watershed, a group of watersheds, a maturity band, a group of maturity bands, etc.), etc. It should be appreciated that other system embodiments may include hundreds or thousands, or more or less, plots, and tens, hundreds or thousands of fields, regions, etc.

The growing spaces 102 may be part of any type of plots or fields in which crops are grown and harvested, or may cover multiple plots or fields. The growing spaces 102 may be owned by the user 103, or otherwise operated and/or managed by the user 103, for example, in the business of growing, harvesting, and selling crops. In connection therewith, the user 103 may be associated with planting seeds into the growing spaces 102, and then imposing management practices as the seeds grow into plants (e.g., in season, etc.) (e.g., through treatments, irrigation, etc.), and then harvesting the crops with a variety of different farm equipment (e.g., planters, sprayers, combines, pickers, etc.) (as explained below).

In connection with the above, data (e.g., agronomic data, etc.) is gathered at or from the growing spaces 102. The data may be gathered manually, or automatically, for example, by farm equipment, etc. The data may include plant/seed identifiers, plant/seed types, crop type, seed products (e.g., traits, maturity, etc.), and/or variety identifiers, plant performance (e.g., yield, height, moisture, maturity, etc.) (e.g., at one or more regular or irregular interval(s), etc.), soil conditions (e.g., moisture, pH level, etc.), weather conditions (e.g., precipitation, temperature, precipitation, sun exposure, humidity, classes, etc.), plant growth stages, planting dates, planting densities, field productivities, soil data, growing temperature days, location data (e.g., latitude./longitude, different zones designations (e.g., maturity zones, environmental zones, weather zones, etc.), field identifiers, treatments (e.g., irrigation, etc.), and other suitable data to identify the seed/plant, a performance of the seed/plant, seed characteristics including agronomic traits (e.g., standability, iron deficiency chlorosis, etc.), plant disease resistance, etc., in the growing spaces 102 (e.g., by region, field, etc.).

Although data is described in some example embodiments with reference to growing spaces 102, it should be appreciated that data may be gathered at the plot level, at the field level (e.g., for more than one plot, etc.), at a region level (e.g., for multiple fields and multiple plots, etc.), etc.

With continued reference to FIG. 1, the system 100 also includes farm equipment 106, a data server 108 (or multiple data servers), and an agricultural computer system 116, each of which is coupled to (and is in communication with) one or more network(s). The network(s) is/are indicated generally by arrowed lines in FIG. 1, and may each include, without limitation, one or more of a local area network (LAN), a wide area network (WAN) (e.g., the Internet, etc.), a mobile/cellular network, a virtual network, and/or another suitable public and/or private network capable of supporting communication among parts of the system 100 illustrated in FIG. 1, or any combination thereof.

In this example embodiment, the farm equipment 106 (broadly, agricultural apparatus) may include, without limitation, harvesting devices, sprayers, planters, seeders, etc., each disposed in the growing spaces. For example, the farm equipment 106 may include, for example, a planter (as shown in FIG. 1), a sprayer, a tiller, an irrigator, a combine, picker, or other types of machines for performing one or more suitable tasks in the growing spaces 102. It should also be appreciated that a different number and/or type of farm equipment, which may be distributed differently among the different growing spaces 102, may be included in other system embodiments.

The farm equipment 106 is configured to measure, capture, or identify data, and additionally to compile data, which is specific to the defined task of the machine, the crop and/or growing spaces 102 as the equipment is performing the defined task(s) related to the crop or growing space 102, etc. The data may include, without limitation, rates, soil compositions, times, dates, yield, weights, applications, moisture content, volumes, flow, or other suitable data, etc., relating to planted seeds, treatments, irrigation, harvested crops, etc. Moreover, in this example, the farm equipment 106 may be configured to track its locations at given times, as each traverses the growing spaces 102, as expressed in latitude/longitude coordinates, or otherwise, and to correlate the locations to other data gathered/compiled by the farm equipment 106 (e.g., permitting the data to be correlated to a specific plant and/or seed based on planting data for the growing spaces, etc.).

The farm equipment 106 may be configured to measure, capture or identify soil information, such as a soil moisture content, pH level, drainage level, etc. For example, the farm equipment 106 may include one or more instruments for measuring a current moisture level of the soil, for measuring a rate of water drainage from the soil over time, measuring pH levels in the soil, etc. Additionally, or alternatively, the growing spaces 102 may include one or more instruments for measuring soil conditions to generate soil data, whereby the user 103 and/or soil investigator may obtain soil samples from the growing spaces 102 periodically to determine soil conditions, etc. It should be appreciated that the farm equipment 106 and/or the instruments at the growing spaces 102 may be configured to capture weather data, such as, for example, temperature, precipitation, sun exposure, humidity, wind, etc.

Alternatively, or in addition, soil data and/or weather data specific to the growing spaces 102 may be obtained from one or more databases, including, for example, public databases from the external data 120 of an external data server 122. One example database may include the SSURGO database and/or the SoilGrid250 database for certain types of soil data, while another example database may include the ERA5 database for certain types of weather data, and SRTM database for topographical data. The soil and topographical data may be for a present season, or a recent history of the growing spaces 102, while the weather data may be for a number of previous years, in general or at specific time periods throughout the year.

The farm equipment 106 is further configured herein to transmit the collected/gathered data to the data server 108, depending on the particular growing space(s) for which the data relates. That said, a different number of data servers 108 may be included in other system embodiments, with the different data servers 108 each being specific to certain ones (or more) of the growing spaces 102, or not.

It should be understood that the data related to the growing spaces 102 and crops/seeds therein may further be identified, measured, collected and/or reported in one or more different manners. For example, the user 103 may inspect the crops and/or growing spaces 102 to observe performance of crops. Crop and/or seed product performance may be identified via visual inspection, a specified test protocol, and/or any other suitable techniques for determining how crop growth has performed, such as a crop yield, crop height, crop moisture, crop maturity, etc. The crop and/or seed product performance observations may indicate a level of performance on a scale, or may include numerical measurements of crop performance according to measurement protocols (such as average volume of crop yield, average crop height, etc.), etc. The crop and/or seed product performance observations may then be communicated to the data server 108 in any suitable manner. For example, the crop and/or seed product performance observations may be logged or reported through a data input tool, such as, for example, the CLIMATE FIELDVIEW, commercially available from Climate LLC, Saint Louis, Missouri, etc. Crop performance and/or seed product performance data may be obtained from other suitable sources, such as commercial research trials, field trials, etc., (which may study growth and performance of different crop types and/or seed products under different growing conditions at various locations of growing spaces).

Apart from the data generated and/or collected from the growing spaces 102, the seeds planted in the growing spaces 102 are associated with a variety of different data, as it relates to the phenotypic and genotypic features thereof. For example, in connection with breeding the particular seed (e.g., genetic information, etc.), certain data related to relative maturity (RM), height, yield, drought tolerance, agronomic traits (e.g., standability, iron deficiency chlorosis, etc.), plant disease resistance, seed supply data (e.g., indicating available seed products, etc.), etc., is compiled. The data may be identified through a seed catalog entry for the specific seed. The data is stored and/or collected to the data server 108. In addition, the data server 108 includes a variety of different data specific to the genotypic information of the seeds, and the specific varieties of the seed is included in the data server 108. The genotypic data may include the specific identifiers and genetic sequences (in whole or in part), trait stacks, markers, and other data indicative of the specific variety, as compared to other varieties at a genetic level, etc.

It should be understood that the data server 108 may be configured to access and/or retrieve soil data and/or weather data from the external data server 122, as appropriate and/or desired for the growing spaces 102, over one or more periods of time. The data server 108 may be configured to also access and/or retrieve other data as described herein.

In addition, the received agricultural data may be associated with a wide range of feature data related to the seeds, environmental and/or testing conditions, and yield properties. In connection therewith, general categories of such feature data may relate to weather, maturity group zones, soil conditions, environmental classifications, field management practices, and/or overall genetic-by-environment (G×E features) that capture non-additive interactions between genetic and environmental features. Other categories of such feature data may include genetic-by-management features (G×M) and genetic-by-environment-by-management features (G×E×M), which respectively capture non-additive interactions between genetic and management features, and interactions between genetic, environment, and management features. As used herein, G×E is a general term of engineered features that take into account variability due to a variety of seeds performing differently under different environmental conditions, which may also consider management features.

The data server 108, in turn, is configured to store the received data in one or more data structures. In general, in this example embodiment, the data server 108 is configured to store data by year (e.g., Year_X, Year_X+1, etc.), which corresponds to the different growing years (e.g., 2019, 2020, 2021, etc.) for the growing spaces 102 (and/or trials, plots, fields, etc., within the growing spaces, etc.). Then, for each year, the data includes data for each of the plots/fields/growing spaces including, for example (and without limitation), performance of multiple different crop types and varieties in various growing spaces (such as crop yield, crop height, crop maturity, crop moisture, etc.), identifiers, brands for seeds, planting dates, growing temperature days, growing mode of action, prior crops, types of traits or trait stacks, treatments, positions/distributions of seeds in the growing spaces 102 (e.g., seeding rates, etc.), location definitions of or within the growing spaces 102 (e.g., field boundaries, latitude and longitude, centroid of a plot or other boundary, etc.), acreage of the growing spaces, populations of seeds planted in the growing spaces 102, yields and harvest grain moisture (e.g., based on location and seed products, etc.), etc. The data may also include soil conditions (e.g., soil moisture, pH levels, drainage levels, etc.), field elevations (which may include slopes of a plot, surrounding terrain information, etc.), precipitation amounts, relative humidity, temperature, solar radiation, irrigation amounts, management practices (e.g., crop rotation, fungicide application, tiling, drainage, etc.) or any other data indicative of the growing conditions for the seeds/plants in the given growing spaces 102, etc.

It should be appreciated that any available and/or desired data may be collected with regard to the growing spaces 102 and/or the crops planted therein.

Given the above, in this example embodiment, the agricultural computer system 116 is programmed, or configured, to receive a request for a seed recommendation related to seeding of a target growing space. For example, the user 103 may make the request with regard to one or more of the growing spaces 102 (which is then a “target growing space”), where the request then includes one or more candidate seed types, and a location of the one or more growing spaces 102. In various implementations, the user 103 may submit the request for the seed recommendation, prior to a seed planting date for a next growing season (e.g., via the CLIMATE FIELDVIEW application, etc.).

Based on the above, in this example embodiment, the agricultural computer system 116 is configured to train a seed placement prediction model 170 and/or a portfolio optimization model 180, based on available and appropriate data, and then to generate the requested recommendations, etc., based on the trained seed placement prediction model 170 and/or a portfolio optimization model 180, as described herein.

In particular, in this exemplary embodiment, the agricultural computer system 116 is configured to access data from the data server 108 (and potentially, the external data server 122), which is relevant to the crop performance predictions (e.g., based on locations of the target growing spaces, candidate seed types for planting, etc.).

The agricultural computer system 116 is configured to access data for growing spaces in the region(s) of the target growing spaces, including, without limitation, planting dates (e.g., days of the year in which crops were planted in the fields, etc.), seeding rates for the fields, modes of action (e.g., a succinate dehydrogenase inhibitor (SDHI), a demethylation inhibitor (DMI), quinone outside inhibitors (QoI), or other effectivity targets of treatment, etc.), performance (e.g., yield, etc.), genetic data for the specific variety of seed consistent with the one or more candidate crop types and/or seed products, weather data, product maturity (e.g., relative maturity (RM), etc.), drought data, previous year crops (broadly, crop rotation), soil data, location data, tillage types, binned application timing, etc. It should be appreciated that the accessed data, in this example embodiment, will generally include multiple different crops and/or seed products and may be from (or stored in) multiple sources (e.g., five, eight, ten, twenty etc.) of published, public and/or private data.

Based on the desired data being accessed, the agricultural computer system 116 is configured to identify regions for the model training, and specifically in this example, the region 110 in which the target growing space is located.

For example, the agricultural computer system 116 may be configured to identify a county, in general or in which a target growing space is located, based on the boundary definition of the county (along with the location data for the target growing space), or based on a county identifier included in the data associated with the target growing space in the data server 108, etc. In another example, the agricultural computer system 116 is configured to identify a state in which the identified county is located based on the boundary definition of the state (along with the location data for the growing space and/or boundary data for the county), or based on a state identifier included in the data associated with the field in the data server 108, etc. Specific data indicative of the region 110 (in this example) may also be determined or retrieved or conditioned for the regions (e.g., based on a centroid location for the county, based on a centroid location for the state, etc.).

It should be appreciated that the data described herein may be accessed, and then limited based on specific region(s) in which the target growing space, or only data specific to the region(s) in which the target growing space is located may be accessed.

It should also be appreciated that other regions may be identified in other example embodiments for accessing data, based on different data, regions, bands, etc. (e.g., maturity bands, watersheds, etc.). For example, the region for accessing data may extend to a third (or more) regions (broader than the region 110), such as, for example, a country, whereby the region hierarchy includes county, state and country, etc., in one example, and/or a city, whereby the region hierarchy includes city, county, state (and then, potentially even further, country).

The agricultural computer system 116 may be configured to manipulate the accessed data (e.g., average, mean, etc.) and to assign the manipulated data for the growing space, or region, to a centroid location thereof (e.g., as part of a feature selection operation where G×E features may be selected for using in training the model(s) herein, etc.). For example, average seeding rate, average planting day of the year, total yield, and/or mean product maturity may also be determined or retrieved, by the agricultural computer system 116, and then assigned, per regional centroid, for the accessed data for the given region(s). As such, the centroid of the growing space 102 may be assigned manipulated crop type and/or seed product performance data for the specific growing space (including any fields or plots therein), and likewise for other growing spaces 102 in the region 110, and/or the regional centroid of the region 110 may be assigned manipulated data (e.g., a yield performance of multiple crop types and/or seed products for the entire region 110, etc.).

In this exemplary embodiment, the agricultural computer system 116 is configured to correlate the genotype data and one or more environmental factors, whereby one or more genetic-by-environmental features (e.g., G×E features, which may include G×E clusters, etc.) are provided.

In connection therewith, in this embodiment, the accessed and/or manipulated data includes, without limitation, yield data (e.g., including product trial data, field data (e.g., split planting data, etc.), etc.), environmental data (e.g., SSURGO soil data, topographic information, maturity group zones, macro-environmental zones, weather class, field productivity, planting dates, planting density, and the GXE features), etc. The data is then separated into a training data set and a validating data set, where each data set includes specific crop performance observation data, growing space data, etc., as described above. The training data and the validation data may be separated randomly and/or based on specific rules (e.g., based on leave one year out (LOYO) schemes or related schemes, etc.), etc.

In connection with the above, in one example, the agricultural computer system 116 may be configured to utilize the accessed/received agricultural data for a soy seed placement model to generate predicted yield properties for a soy variety seeds associated with particular fields, particular management practices, and/or particular environments. In particular in this example, the agricultural computer system 116 may be configured to use a statistical mixed effects model to combine various terms in the following mathematical representation: Yield (bu/ac)=f (G+E+G×E+error). Here, term G represents genetic feature information for the list of soy varieties. The term E represents environmental and/or management features for a set of fields, and may include SSURGO soil data, maturity group zones, environmental zones, weather class, crop rotation, tillage practice, and the like. The term G×E is a mathematical term that captures non-additive interactions between genetic features and environmental/management features. For instance, G×E may capture variability due to a variety seeds performing differently under different environmental conditions, which may also consider management features. And, the error term accounts for yield variations not captured by the G, E, and G×E terms.

Next in the system 100, the agricultural computer system 116 is configured to access the seed placement prediction model 170, which, in this example embodiment, is a multilayer perceptron (MLP) neural network field-level relative yield prediction model. Other examples of models may include XGBoost, elastic net, etc., models. The seed placement prediction model 170 is configured to output a matrix of placement data, which is defined by three variables: weather year, type of seed (or variety), and yield predictions. It should be appreciated that the seed placement prediction model 170 may include a different type of model and/or provide a different form of output in other embodiments.

Multiple different model setups of the seed placement prediction model 170, based on a specific model type, are presented in the TABLE 1, below. It should be appreciated that the setup parameters provided below are example in nature and are provided for purposes of illustration, and that other setup parameters may be employed in other implementations of the seed placement prediction model 170.

TABLE 1

XGBoost: Hyperparameters range:
max_depth: [6, 20]
min_child_weight: [1, 10]
subsample: [0.5, 1]
colsample_bytree: [0.5, 1]
Learning rate - eta: [0.001, 0.1]
Lasso penalty - lambda: [0.001, 0.1]
Early stopping is implemented as 10 rounds
Neural network: Hyperparameters range:
n_hidden_layers: [1, 2, 3]
n_nodes_hidden_layer: [20, 2*n_features]
Dropout_rate: [0.01, 0.5]
Learning_rate: [0.000006, 0.1]
Loss: [mae, mse]
Elastic net: Hyperparameters range:
Alpha: [0.001, 5]
L1_ratio: [0.01, 1]

The agricultural computer system 116 is configured to train, based on the training data, the seed placement prediction model 170. And, then, the agricultural computer system 116 is configured to then validate the seed placement prediction model 170, based on the validation data. In general, the model is validated when the percentage of correct predictions provides a performance, and when the performance of the trained model(s) is as desired or expected, the trained model(s) are stored in memory and designated, by the agricultural computer system 116, for use in providing crop yield predictions and/or seed portfolio planting recommendations related to the original request (and/or others).

In addition to the seed placement prediction model 170, the agricultural computer system 116 is configured to access the portfolio optimization model 180. In this embodiment, the optimization model is configured to balance yield, risk, and convenience to simplify seed decisions. The portfolio optimization model 180 leverages the field data from the grower(s), and also the yield performance predictions from the seed placement prediction model 170, in order to prescribe a recommendation. The portfolio optimization model 180 may further be configured to optimize for one or more other and/or different objectives, such as, for example, high performing products on high productivity fields, stable products on low productivity fields, relative maturity, agronomic trait/disease resistance optimization, etc. The objectives may be further balanced with multi-objective optimization, for example, to optimize for minimum total weighted distance to utopia points. It should be appreciated that one or more combinations of the objectives may be imposed through the portfolio optimization model 180, or otherwise.

In this exemplary embodiment, the portfolio optimization model 180 includes a linear programming (MILP) open source solver (PuLP) and adopts bi-objective (“efficient frontier”) portfolio formulation techniques.

In particular, as it relates to the objectives above, the optimization model 180 relies on input data, which includes the output matrix from the seed placement prediction model 170 (e.g., a matrix such as predicted yield of weather year by seed type by field, etc.), seed characteristics including agronomic traits (standability, iron deficiency chlorosis, etc.), plant disease resistance, grower field info (ID, acres, field productivity, location (e.g., latitude/longitude, etc.)), and also grower preferences (e.g., relative maturity (RM) minimum/maximum, weighted averages, brand mix, trait mix, etc.) and seed supply, etc. In addition, the portfolio optimization model 180 further relies on the specific identifying information of the specific field (e.g., field identifier, acres, location, etc.), grower average planting rates (in general, or for the field), and seed order (e.g., variety and volume, etc.), etc.).

As it relates to the optimization model 180, in this example embodiment, the model includes a mixed integer linear programming model to optimize seed selection and single variety field assignment, given the above inputs (e.g., including grower preferences and supply list, etc.). The portfolio optimization model 180 is configured to incorporate certain objectives, including, for example, to limit operation-level weather risk based on a mean absolute deviation of predicted yield across historical weather year scenarios; to enhance operation-level acre-weighted mean yield; high performing products on high productivity fields, stable products on low productivity fields, agronomic trait/disease resistance optimization; and/or to limit spatial span metric, where the span metric includes i) relative maturity (RM) difference in field clusters within an operation, given cluster information ii) RM differences between adjacent fields within an operation, given field adjacency information, and/or iii) sum of RM differences between adjacent fields within an operation, given field adjacency information.

The constraints on the optimization model 180 includes, for example, without limitation a number of selected seeds that is within an input preferred range, an acre fraction of selected brands that is within an input preferred range, an acre fraction of newly launched products that is within an input preferred range, a planting/harvest window that is within an input preferred range, an acre fraction of selected traits that is within an input preferred range, an acre fraction of a single variety that is within the input preferred value, a seed volume of a single variety that is within an input preferred value, and/or a minimum, maximum, and acre-weighted mean RM of selected portfolio that is within an input preferred ranges.

Further, when used for field assignment, the optimization model 180 is also limited to assign a product quantity, which at least matches the purchased quantity, within an input preferred tolerance.

As it relates to the objective of limiting operation-level weather risk, the optimization model 180 relies on the expression in Equation Set (1).

$$\begin{matrix}min \frac{1}{T} {\sum }_{t = 1}^{T} {y}_{t} \\ {y}_{t} - {\sum }_{j ∈ F} {s}_{j} ( {\sum }_{i ∈ V} ( {r}_{ij , t} - {\hat{μ}}_{ij} ) {x}_{ij} ) \geq 0 , t = 1 , … , T \\ {y}_{t} + {\sum }_{j ∈ F} {s}_{j} ( {\sum }_{i ∈ V} ( {r}_{ij , t} - {\hat{μ}}_{ij} ) {x}_{ij} ) \geq 0 , t = 1 , … , T\end{matrix} \qquad ( 1 )$$

In Equation Set (1), T is the number of scenarios; yₜ, t=1, . . . , T are auxiliary decision variables that facilitate the linearization of the objective function; F is a field set; s; is a size of a particular field j of the field set F (e.g., in acres, etc.); V is a variety set of seeds; r_{i,j,t} is the yield of seed variety i of the variety set V on field j of the field set Fin scenario t, t=1, . . . , T; \hat{r}_{i,j,t} is a yield prediction for seed variety i of the variety set V on field j of the field set Fin scenario t, t=1, . . . , T; \hat{μ}ᵢⱼ=Σₜ₌₁^{T} \hat{r}_{i,j,t}/T approximates E[rᵢⱼ]; and xᵢⱼ is a binary variable that equals 1 if seed variety i is assigned to field j and equals 0 otherwise.

The above is optionally subject to minimum acceptable portfolio mean yield, as follows:

$${\sum }_{j} {s}_{j} {\sum }_{i} {x}_{ij} {\hat{μ}}_{ij} \geq {μ}_{-} {\sum }_{j} {s}_{j}$$

In the above, μ is set as maxᵢⱼ[μᵢⱼ]−Δ and Δ is adjusted to obtain a risk-mean efficient frontier.

As it relates to the objective of limiting operation-level mean yield, the optimization model 180 relies on the expression in Equation Set (2).

$$max \frac{{\sum }_{j} {s}_{j} {\sum }_{i} {x}_{ij} {\hat{μ}}_{ij}}{{\sum }_{j} {s}_{j}} \qquad ( 2 )$$

In Equation Set (2), F is a field set; s, is a size of a particular field j of the field set F; xᵢⱼ is a binary variable that equals 1 if seed variety i is assigned to field j and equals 0 otherwise; and \hat{μ}ᵢⱼ=Σₜ₌₁^{T} \hat{r}_{i,j,t}/T again approximates E[rᵢⱼ]. In addition, the above is optionally subject to either: i) maximum allowed risk, to create yield vs risk efficient frontier tradeoff; or ii) minimum allowed spatial span metric (see objective 3 below), to create yield vs convenience efficient frontier tradeoff.

As it relates to the objective of limiting the spatial span metric, the optimization model 180 relies on the expressions in Equation Sets (3)-(5), optionally subject to minimum acceptable portfolio mean yield to create yield versus convenience efficient frontier. In particular, in order to minimize cluster RM difference, given cluster information may be applied follows:

$$\begin{matrix}{\sum }_{i ∈ V} {x}_{ij} {RM}_{i} \leq {RM}_{c , max ,} j ∈ cluster c \\ {\sum }_{i ∈ V} {x}_{ij} {RM}_{i} \geq {RM}_{c , max ,} j ∈ cluster c \\ {RM}_{c , max} - {RM}_{c , min} \leq δ\end{matrix} \qquad ( 3 )$$

In the above, xᵢⱼ is a binary variable that equals 1 if seed variety i is assigned to field j and equals 0 otherwise; RMᵢ is a relative maturity of the seed variety i; c is a cluster of cluster set C wherein each cluster c includes one or more fields; RM_{c,max} and RM_{c,min} are auxiliary decision variables for each RM cluster for cluster c; and δ is a specified parameter. And, in order to minimize RM_diff, or adjacent field RM difference, given adjacent field information may be applied as follows:

$$\begin{matrix}{\sum }_{i ∈ V} {RM}_{i} {x}_{ij} - {\sum }_{i ′ ∈ V} {RM}_{i ′} {x}_{i ′ j ′} \leq RM\_diff , for ( j , {j}^{′} ) ∈ a list of adjacent pairs \\ {\sum }_{i ∈ V} {RM}_{i} {x}_{ij} - {\sum }_{i ′ ∈ V} {RM}_{i ′} {x}_{i ′ j ′} \geq - RM\_diff , for ( j , {j}^{′} ) ∈ a list of adjacent pairs\end{matrix} \qquad ( 4 )$$

In the above, xᵢⱼ is a binary variable that equals 1 if seed variety i is assigned to field j and equals 0 otherwise; x_{i′j′} is a binary variable that equals 1 if seed variety i′ is assigned to field j′ and equals 0 otherwise; RMᵢ is a relative maturity of the seed variety i; RMᵢ, is a RM of the seed variety i′; and RM_diff is a relative maturity threshold that is a specified parameter. And, in order to minimize sum_RM_diff, or the sum of adjacent field RM differences, given adjacent field information may be applied as follows:

$$min {\sum }_{( j , {j}^{′} ) ∈ a list of adjacent parameters} {w}_{jj ′} {Diff}_{jj ′} \qquad ( 5 )$$

In the above, wⱼⱼ, defines weights for each adjacent pair of fields (j, j′); and Diffⱼⱼ, is an absolute relative maturity difference of each pair of adjacent fields (j, j′).

In addition to, or alternatively, the objective of limiting the spatial span metric may be otherwise implemented in the optimization model 180, where the RM spread in a cluster is simplified further over the above, in various embodiments. In connection therewith, relevant data elements are defined in TABLE 2, and decision variables are defined in TABLE 3.

TABLE 2

B: Set of RM bins (buckets)
ϵ^{O}: Allowable tolerance for RM spread at operational level
G: Set of RM units (like {1.1, 1.2, etc}
gᵢ, i ∈ V: RM unit of variety i
G_{b}: Set of RM units aggregated into bin b
ϵ^{C}: Allowable tolerance for RM spread at cluster level

TABLE 3

σ^{O}: RM spread violation at operational level
σ^{C}: RM spread violation at cluster level
ƒ_{b}, b ∈ B: The total fraction of the portfolio allocated to RM bin b
e_{c}^{min}, c ∈ C: Minimum RM of cluster c
e_{c}^{max}, c ∈ C: Minimum RM of cluster c

Based on the above, the model constraints for the optimization model 180 may be implemented as follows:

$$\begin{matrix}{f}_{b} = ( \frac{1}{{\sum }_{j ∈ F} {s}_{j}} ) {\sum }_{i ∈ V ; {g}_{i} ∈ {G}_{b}} {\sum }_{j ∈ F} {s}_{j} {x}_{ij} & ∀ b ∈ B \\ {f}_{b} - {f}_{{b}^{′}} \leq {ϵ}^{0} + {σ}^{0} & ∀ b , {b}^{′} ∈ B ; b \neq {b}^{′}\end{matrix} \qquad ( 6 )$$

The model constraints, in this example, further seek to minimize deviation of RM, overall, while additional constraints of the optimization model 180 in the expression below seek to minimize variation in a cluster.

$$\begin{matrix}{g}_{i} {x}_{ij} \leq {e}_{c}^{max} & ∀ i ∈ V , j ∈ c , c ∈ C \\ {g}_{i} {x}_{ij} \geq {e}_{c}^{min} & ∀ i ∈ V , j ∈ c , c ∈ C \\ {e}_{c}^{max} - {e}_{c}^{min} \leq {ϵ}^{C} + {σ}^{C} & ∀ c ∈ C\end{matrix} \qquad ( 7 )$$

In various embodiments, field productivity may be employed as an objective for the optimization model 180, where, for example, high performing products are assigned to high productivity fields, stable products are assigned to low productivity fields, etc. In connection therewith, field productivity classifies fields and varieties into categories and enables the optimization model 180 to assign ideal matching categories, which include high productivity fields (H); mid productivity, sable fields (MS); mid productivity, unstable fields (U); and low productivity fields (L). Rewards, C, are then defined for the assignments of the products to the respective field productivity, for yield and risk, where low risk, high yield is a higher reward, as compared to high risk, low yield, as shown, for example, in FIG. 1A. The rewards C are assigned based on risk yield and also field productivity. The associated data elements are defined in TABLE 4, below.

TABLE 4

| | |
|---|---|
| F^{α} | Fields in category α ∈ {H, MS, MU, L}. |
| V^{β} | Varieties in category β ∈ {H, M, L}. |
| C^{α, β} | Reward for assigning variety in category β to field category α. |

The optimization model 108 further includes weighting of the objective function for field productivity whereby the reward(s) may be for field productivity by field size. The term, when only H,H and L,L is rewarded, is applied as follows:

$$\frac{{\sum }_{i ∈ {V}^{H}} {\sum }_{j ∈ {F}^{H}} {C}^{H , H} {s}_{j} {x}_{ij} + {\sum }_{i ∈ {V}^{L}} {\sum }_{j ∈ {F}^{L}} {C}^{L , L} {s}_{j} {x}_{ij}}{( {\sum }_{j ∈ F} {s}_{j} )} \qquad ( 8 )$$

In addition to the above, the optimization model 180 may further account for objectives related to one or more specific agronomic traits in the optimization. The agronomic traits may include, for soy varieties, for example, standability, PRR-field tolerance, etc. The characteristics are available either as a numerical score or as a binary present/not-present format. The impact of the characteristics for growers in a RM-zone are estimated and provided to the optimization model 180 as normalized weights. These weights are obtained from breeding characteristic trait index data. More formally, the data elements included in the characteristic trait index data are defined in TABLE 5.

TABLE 5

| | |
|---|---|
| T⁽¹⁾ | Set of ag-traits with a numerical score |
| T⁽²⁾ | Set of ag-traits with nominal value |
| τ_{i, t} | Positive deviation of ag-trait score of variety i for ag |
| | trait t ∈ T⁽¹⁾ from the desirable threshold for ag trait t |
| V^{(t, 2)} | Set of varieties without nominal trait t, t ∈ T⁽²⁾ |
| λ_{j, t} | The importance weight for trait t in field j. This is |
| | obtained from characteristic trait index data. |
| η^{max} | Maximum (worst-case) score for numerical ag-traits. |
| | This is assumed to be the same for all traits t ∈ T⁽¹⁾. |
| η^{min} | Minimum (best-case) score for numerical ag-traits. |
| | This is assumed to be the same for all traits t ∈ T⁽¹⁾. |

The overall risk measure is defined by the expression presented below and represented by y. Recall that sⱼ is the size of field j. The first term is the risk due to ag-traits with a numerical score and the second term is for traits with a nominal value.

$$\frac{{\sum }_{i ∈ {T}^{( 1 )}} {\sum }_{i ∈ V} {\sum }_{j ∈ F} {s}_{j} {λ}_{j , t} {τ}_{i , t} {x}_{i , j}}{( {η}^{max} - {η}^{min} ) ( {\sum }_{j ∈ F} {s}_{j} )} + \frac{{\sum }_{i ∈ {T}^{( 2 )}} {\sum }_{i ∈ {V}^{( t , 2 )}} {\sum }_{j ∈ F} {s}_{j} {λ}_{j , t} {x}_{ij}}{( {\sum }_{j ∈ F} {s}_{j} )} \leq γ \qquad ( 9 )$$

In addition to the above, the optimization model 180 is employed to reduce the risk of lower yield due to variance in yield due to different weather scenarios. Above, the optimization model 180 is configured to penalize weighted absolute deviation from expected yield. Alternatively, in this example, the optimization model 180 may be configured to penalize only negative outcomes, like yield lower than a specified threshold, and also the count of negative outcomes. In connection therewith, relevant data elements are defined in TABLE 6, and decision variables are defined in TABLE 7.

TABLE 6

| | |
|---|---|
| πₜ | Probability of scenario t, |
| | currently each weather year |
| | scenario is considered |
| | equally likely. |
| p | Lower bound threshold for |
| | operation level yield. |
| μ | Minimum acceptable yield. |

TABLE 7

| | |
|---|---|
| hₜ | Indicator of negative |
| | outcome for scenario t. |
| θ | Fraction of negative outcomes. |
| pₜ | Portfolio yield in scenario t |

The optimization model 180 is then constrained based on the below. The variable hₜ is binary and is forced to be 1 when pₜ≤p.

$$\begin{matrix}θ = {\sum }_{t = 1}^{T} {π}_{t} {h}_{t} \\ \begin{matrix}{p}_{t} \geq ( 1 - {h}_{t} ) {p}_{-} & ∀ t ∈ \{ 1 , … , T \}\end{matrix} \\ {p}_{t} = {\sum }_{i ∈ V} {\sum }_{j ∈ F} {s}_{j} {r}_{ijt} {x}_{ij} \\ μ = {\sum }_{t = 1}^{T} {π}_{t} {p}_{t} \\ μ \geq {μ}_{-}\end{matrix} \qquad ( 10 )$$

The constraints herein limit the solution space such that the model is configured to find optimal points that maximize the objective function for each yield/risk level, or one or more other suitable or desirable objectives. This solution space forms an efficient frontier.

In various exemplary embodiments, the efficient frontier (EF) strategy may be implemented to include: i) yield vs risk: obtain maximum mean yield possible (objective 2) and mean yield corresponding to minimum risk possible (objective 1), setting these to be EF extrema. Then, minimize risk (objective 1) subject to mean yield constraints given allowable values under EF extrema; or ii) yield vs convenience (spatial metric): obtain maximum mean yield possible (objective 2) and mean yield corresponding to minimum spatial metric possible (objective 3), setting these to be EF extrema. Then, maximize yield (objective 2) subject to allowable spatial metric values under EF extrema. When more than two objectives are optimized, the objectives may be balanced, in one or more embodiments, with multi-objective optimization, to optimize for minimum total weighted distance to the utopia points. The utopia point is the desired solution for each objective.

That is, the optimization model 180 may be based on multiple objectives, as explained above, where the count of objectives considered is flexible in one or more embodiments. In such an embodiment, a list of objectives that must be considered may include, for example, f₁, f₂, . . . , f_{N}, where A^{min} and A^{max} represent the set of objectives that must be minimized and maximized, respectively.

Initially, the minimum, for i∈A^{min}, and maximum, for i∈A^{max}, is determined for each objective i=1, . . . , N independently. The optimal objective function value for each objective is referred to as utopia-points, denoted as fᵢ^{U}, i=1, . . . , N. Considering the utopia points, the efficient frontier is sampled by minimizing a centered and weighted combination of each objective function as shown below.

$$\begin{matrix}min {\sum }_{n ∈ {A}^{min}} {ω}_{n} ( {f}_{n} - {f}_{n}^{U} ) + {\sum }_{n ∈ {A}^{max}} {ω}_{n} ( {f}_{n}^{U} - {f}_{n} ) \\ s . t . operational constraints \\ {f}_{1} , … , {f}_{N}\end{matrix} \qquad ( 11 )$$

From the above expression, as it relates to the optimization model 180, each sample corresponds to a new set of weights ωᵢ, i=1, . . . , N.

As above, the agricultural computer system 116 is configured to train the optimization model 180 and validate the optimization model 180, based on the training and validation data. As above, the percentage of correct predictions provides a performance, and when the performance of the trained model(s) is as desired or expected, the trained model(s) are designated, by the agricultural computer system 116, for use in providing crop yield predictions and/or seed portfolio planting recommendations related to the original request (and/or others).

After each is validated consistent with the above, the agricultural computer system 116 is configured to store the trained seed placement prediction model 170 and/or the optimization model 180 in memory.

It should be understood that, in this example embodiment, the seed placement prediction model 170 and/or the portfolio optimization model 180 is trained, by the agricultural computer system 116, in response to the request from the user 103, for example, for the yield prediction and recommendation regarding multiple candidate seed types for the target plot. That said, in other embodiments the agricultural computer system 116 may be configured to train the model(s) for specific combinations of candidate seed types and regions, whereby the model(s) may be trained and validated in advance of the request from the user 103, or another user in any of the growing spaces 102, regions 110, or other regions, etc.

What's more, it should be appreciated that once trained (either in response to a request, or in general), the model(s) may be updated or retrained at one or more intervals, to, for example, promote the inclusion of up-to-date information from the growing spaces 102 (e.g., plots, fields, etc.) in the regions 110. The interval may be weekly, monthly, bi-monthly or a shorter or longer interval depending, for example, on the available data from the regions 110 (e.g., which may alter the model, etc.).

After the models are trained, and stored, the agricultural computer system 116 is configured, by using the seed placement prediction model 170 and the portfolio optimization model 180, to determine, in response to the user's request, and to recommend to the user 103, a seed portfolio for planting in one or more of the growing spaces 102 (e.g., of a target field from the request, etc.).

In connection therewith, the agricultural computer system 116 is configured to make the prediction of crop performance likelihoods by inputting the details of the target growing space to the trained seed placement prediction model 170. For example, in some implementations, only a location of the target growing space may be input to the trained seed placement prediction model 170, and the agricultural computer system 116 is then configured, using the trained placement prediction model 170, to output a placement matrix, which includes the yield likelihoods (and optionally, variances of the yield likelihoods) for the target plot for multiple candidate crop types and/or seed products, at the location of the target growing space for different weather years. In some implementations, the input to the trained seed placement prediction model 170 may include other characteristics of the target growing space, including but not limited to, soil information of the target growing space, weather information associated with the target growing space, crop type and/or seed product information associated with the target growing space, etc.

The agricultural computer system 116 is configured to make the recommendations of seed portfolios for various candidate crop types and/or seed products, using the trained portfolio optimization model 180, based on one or more grower constraints (e.g., grower seeding rate preferences, relative maturity spread preferences, a preferred range of varieties, preferred product volume, preferred mixes of seed traits and brands, etc.), and an output matrix from the seed placement prediction model 170 (e.g., weather year×seed type×predicted yield, etc.). For example, in some implementations, only a grower constraint and the output of the seed placement prediction model 170 may be input to the trained portfolio optimization model 180, and the agricultural computer system 116 is then configured, by the trained model, to output a recommended seed portfolio for planting seeds of one or more candidate crop types and/or seed products, at the location of the target growing space.

In this exemplary embodiment, the agricultural computer system 116, then, is configured to issue an output as a recommendation to the user 103 (e.g., via a transmission to a communication device 104 associated with the user 103, etc.) of a recommended seed portfolio for planting in the target growing space, consistent with the predicted crop yields and the optimized seed portfolio output (as indicated in the request).

With continued reference to FIG. 1, in this example embodiment, the agricultural computer system 116 is programmed, or configured, to issue the portfolio recommendations to the user 103 in one or more forms. In particular, the crop yield predictions and/or seed portfolio recommendations may be provided in combination with one or more probabilities in an interface displayed to the user 103 at the communication device 104 (e.g., via the CLIMATE FIELDVIEW application, etc.).

The seed portfolio recommendation may then be selected by the user 103 (e.g., via the CLIMATE FIELDVIEW application, etc.), where the user 103 may then order and/or purchase the seed product(s), for instance, via the agricultural computer system 116, etc. (e.g., whereby the agricultural computer system 116 receives the order, purchase request, etc., from the user 103, in response to output of the seed portfolio decision to the user 103 and a corresponding agreement to the decision and/or recommendation by the user 103, etc.). The agricultural computer system 116 may then direct the selected seeding(s) to the user 103 (e.g., delivering the portfolio of seeds to the target growing space, etc.). Further, the candidate seeds may be applied, by the user 103 or other party, for example, to the target growing space (e.g., as represented by one or more plots, fields, etc.). This may include the user 103 receiving the seeds and operating farm equipment (e.g., one or more of farm equipment 106, etc.) to plant the seeds in the target field. Alternatively, this may include the agricultural computer system 116 generating instructions based on the seed recommendation and providing the instructions to the farm equipment 106, for example, whereby the farm equipment 106 is configured to operate, in response to the instructions, to seed the target growing space (e.g., upon delivery of the recommended seeds to the farm equipment 106, etc.). In one or more embodiments, the farm equipment 106 (e.g., a seeder, planter, etc.) in the target growing space may be controlled automatically, through one or more scripts generated by the agricultural computer system 116, in connection with the instructions.

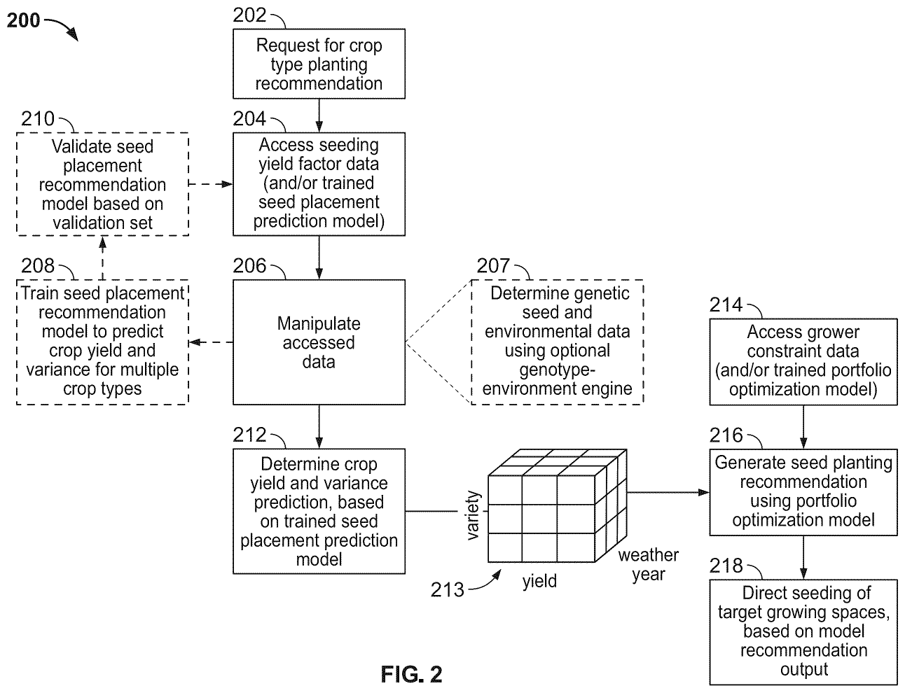

FIG. 2 illustrates an example method 200 for determining which seeds of multiple crop types and/or seed products and varieties to plant in a growing space, based on predictions of specific crop yield likelihoods and possible variances. The example method 200 is described herein in connection with the system 100, and may be implemented, in whole or in part, in the agricultural computer system 116 of the system 100. However, it should be appreciated that the method 200, or other methods described herein, are not limited to the system 100 or the agricultural computer system 116. And, conversely, the systems, data structures, and the computing devices described herein are not limited to the example method 200.

At the outset in the method 200, the agricultural computer system 116 receives, at 202, a request from a user 103, or other user associated with a target growing space (e.g., a target plot, field, etc.) included in the growing spaces in the system 100, for a decision of which seeds of multiple candidate crop types and/or seed products (e.g., soybeans, corn, different varieties of soybeans, different varieties of corn, etc.) should be planted in the target growing space based on a predicted yield of the different crop types and/or seed products (and optionally possible variances of the predicted yields due to varying weather events, etc.), along with a location of the target growing space (and optionally one or more grower constraints, and/or other suitable input parameters characterizing the target growing space). The request may be provided, to the agricultural computer system 116, via the communication device 104 (e.g., via an electronic message (e.g., email, SMS message, etc.), or via a mobile application such as, for example, the CLIMATE FIELDVIEW application, commercially available from Climate LLC, Saint Louis, Missouri, etc.).

In response to the request, in this embodiment, the agricultural computer system 116 accesses particular data, at 204, for the specific request, and in particular, the region 110 that includes the target growing space and the particular candidate crop types and/or seed products. For example, the agricultural computer system 116 may access data, which is specific to the region 110, and the target growing space, in FIG. 1 and for specific candidate crop types and/or seed products, such as soybeans, corn, different specific varieties of soybeans, different specific varieties of corn, etc. Other types of crops (e.g., wheat, canola, cotton, etc.), crop varieties, regions, treatments (e.g., fungicides, pesticides, herbicides, etc.), etc., may be included in other embodiments, whereby the agricultural computer system 116 accesses data specific to those features.

The accessed data may include, for example, various years of crop performance observation data indicative of a yield of various types of crops in various growing spaces at different locations, with different dates of observations and different field conditions for the various growing spaces. The data may be specific to growing spaces, including various different growing spaces (e.g., plots, fields, etc.) at a variety of different locations in the region 110, or other regions. In this embodiment, the data includes different data related to the growing space, crop, seed type, performance, etc., including, without limitation, planting date for the crop, planting day of year, seeding rate, tillage type, surfactant usage, mode of treatment action, yields, weather data (e.g., weather scores, precipitation, relative humidity, temperature, solar radiation, etc.), maturity, drought monitor, previous year crops, location, application timing, crop type and details (e.g., trait stack, relative maturity, etc.), management practices (e.g., crop rotation, tilling, etc.), soil information (e.g., moisture, drainage, etc.), field topology (e.g., elevation, slope, surrounding terrain, etc.), etc.

The data related to soil information may be obtained from the Soil Survey Geographic Database (SSURGO). The data related to weather may be derived from ERA5 data. In some example embodiments, the ERA5 data may be input into an environmental transfer learning model to generate the weather data that may be accessed for the method 200. The data related to the location (including at least the growing space), management (including at least tillage type), surfactant usage, mode of treatment action, and product/ancestry (including at least the previous years crops and crop type and detail) may be obtained from product trials, grower data, etc. In some example embodiments, fingerprint data may be input into a clustering model that generates genetic clusters, which may then be included in the accessed data.

In some example embodiments, data for training the model may include genotype and environmental data. For example, a genotype-environment engine may generate data indicative of an effect of seed genotype and environmental factors on crop yield performance for multiple crop types and/or seed products.

Next in the method 200, the agricultural computer system 116 manipulates, at 206, the accessed data, in whole or in part, to define specific data features, for example. In some example embodiments, the accessed data may be input into a G×E model that may output G×E features. The G×E features and the accessed data may be input into a field placement model that may be configured to analyze the G×E features and the accessed data to output a yield prediction as well as a yield prediction uncertainty. In this example, the agricultural computer system 116 determines the average crop yield for multiple crop types and/or seed products included in the accessed data in different regions (e.g., in region 110, etc.), at different levels. In particular, where a region (e.g., region 110, etc.) includes multiple counties, the agricultural computer system 116 may determine an average crop yield, height, maturity, etc., for multiple crop types and/or seed products in each county and then the region overall. The agricultural computer system 116 then assigns the average crop yield, height, maturity, etc., for multiple crop types and/or seed products to each county and then the region, at a centroid of the county/region.

In addition, as part of manipulating the accessed data, the agricultural computer system 116 may impute data to certain crop performance observations in certain plots, based on the averages in the regions in which the growing spaces associated with the missing data is located.

The accessed, manipulated data is then separated by the agricultural computer system 116 into a training data set and a validation data set, where each set also includes crop performance observation data (e.g., crop yield, height, maturity, etc., observations for multiple crop types and/or seed products at multiple growing space locations and observation dates, etc.).

Optionally, the agricultural computer system 116 may determine, or obtain, genetic seed and environmental data using a genotype-environment engine, at 207. The genetic seed and environmental data may be used as part of the input for training the seed placement prediction model.

At 208, the agricultural computer system 116 then trains the seed placement prediction model (as presented above) based on the accessed and/or manipulated training data set. The seed placement prediction model 170, as explained above, includes a trained model capable of predicting yield likelihoods for multiple crop types and/or seed products, and may include possible variances of the yield likelihoods (e.g., higher or lower yields which may occur depending on a forecasted range of expected weather event outcomes during the growing seasons, such as more or less rainfall, higher or lower temperatures, etc.). In particular, the output of the seed placement prediction model 170 may include both an expected yield likelihood for each seed product and possible variance values associated with the predicted yields. An example yield prediction output array 213 is illustrated in FIG. 2 and discussed further below.

After training is completed, the agricultural computer system 116 validates the model, at 210, based on the validation data set. The validation of the model includes inputting the validation data set features to the trained seed placement prediction model 170 and comparing the output (e.g., prediction of multiple crop types and/or seed products yield likelihoods) to the crop performance observation data included in the validation data set, as an indicator of whether the “correct” crop yield prediction likelihoods were made relative to the appropriate threshold, i.e., as an indication of performance of the trained model. When the performance of the model, as trained, is as desired or intended, the trained model is stored in memory for use as described below.

It should be appreciated that, as indicated by the dotted line in FIG. 2, the agricultural computer system 116 may retrain or update the model in various embodiments, at various intervals, by returning to step 204 to access data specific to crop performance observations for multiple crop types and/or seed products, in different regions. In this manner, the model may be trained or retrained apart from a specific request from the user 103 and/or the trained model may be available for use, by the agricultural computer system 116, without retraining or initially training for each request related to a prediction of yield likelihoods of multiple crop types and/or seed products at a particular growing space location. The retaining may be employed, for example, to account for additional available data since the training of the model.

Next, the agricultural computer system 116 determines, at 212, a yield likelihood for multiple crop types and/or seed products (e.g., a prediction of an expected crop yield at the end of the growing season for a first variety of soybeans, an expected crop yield for a second variety of soybeans, an expected crop yield for a first variety of corn, etc.), based on the trained model, where the details of the request are provided as input(s) to the trained seed placement prediction model 170.

The yield prediction output of the seed placement prediction model 170 may be in the form of yield prediction output matrix 213, as shown in FIG. 2. In this example, the yield prediction output array is a three-dimensional array, with dimensions of seed product or seed type (including different candidate crop types and/or seed products), predicted yield, and field and weather year. Therefore, the yield prediction output matrix 213 includes predicted likelihoods of crop yields for multiple seed types and/or crop varieties, across multiple growing spaces. In addition, the yield prediction output matrix 213 includes a variance of the predicted yield likelihoods for each crop variety based on the variation in weather. For example, the predicted crop yields may vary according to higher or lower rainfall during the growing season, higher or lower temperatures during the growing season, etc.

In this example, the yield prediction output matrix 213 defines information not only about an average expected yield of each seed product, but also possible variances of yield likelihoods. This may indicate which crop types and/or seed products have yield performance that depends largely on the weather (and may be riskier to plant), which crop types and/or seed products have more stable yield predictions, etc.

An example prediction and variance output table for one target growing space is illustrated below in Table 1. The example prediction and variance output table shown in Table 8 is a slice of the output matrix 213, that excludes the field dimension (where the output matrix 213, for example, includes predicted yield by seed product (or seed variety) by field and weather year).

As shown in the example embodiment of TABLE 8, a variety of bushels per acre measurements for three soybean varieties and two corn varieties are provided as related to four weather conditions. In particular, soybean variety 1 yielded 65.1 bu/ac for weather condition 1, 60.9 bu/ac for weather condition 2, 55.1 bu/ac for weather condition 3, and 68.1 bu/ac for weather condition 4. Soybean variety 2 yielded 62.3 bu/ac for weather condition 1, 59.3 bu/ac for weather condition 2, 58.5 bu/ac for weather condition 3, and 71.9 bu/ac for weather condition 4. Soybean variety 3 yielded 58.4 bu/ac for weather condition 1, 57.8 bu/ac for weather condition 2, 57.7 bu/ac for weather condition 3, and 65.0 bu/ac for weather condition 4. Corn variety 1 yielded 208.8 bu/ac for weather condition 1, 199.3 bu/ac for weather condition 2, 189.3 bu/ac for weather condition 3, and 201.4 bu/ac for weather condition 4. Corn variety 2 yielded 202.3 bu/ac for weather condition 1, 204.2 bu/ac for weather condition 2, 196.4 bu/ac for weather condition 3, and 207.9 bu/ac for weather condition 4.

TABLE 8

| | Weather | | Weather | | Weather | | Weather | |
|---|---|---|---|---|---|---|---|---|
| Seed Product | Condition 1 | | Condition 2 | | Condition 3 | | Condition 4 | |
| Soybean | 65.1 | bu/ac | 60.9 | bu/ac | 55.1 | bu/ac | 68.1 | bu/ac |
| variety 1 | | | | | | | | |
| Soybean | 62.3 | bu/ac | 59.3 | bu/ac | 58.5 | bu/ac | 71.9 | bu/ac |
| variety 2 | | | | | | | | |
| Soybean | 58.4 | bu/ac | 57.8 | bu/ac | 57.7 | bu/ac | 65.0 | bu/ac |
| variety 3 | | | | | | | | |
| Corn variety 1 | 208.8 | bu/ac | 199.3 | bu/ac | 189.3 | bu/ac | 201.4 | bu/ac |
| Corn variety 2 | 202.3 | bu/ac | 204.2 | bu/ac | 196.4 | bu/ac | 207.9 | bu/ac |

As should be appreciated, in other embodiments the crop yield prediction output may include more or less different varieties, weather instances, etc. The crop yield prediction output may be presented in forms other than a matrix, may be tailored to include varieties associated with only one type of crop or one seed product (or a specified subset of crop types and/or seed products), may be tailored to specific crop types and/or seed products, may include a yield prediction likelihood output for only one type of variance parameter or for multiple types of variance parameters, etc. A user 103 may specify which growing spaces, crops types, variance parameters, etc., should be included in the crop yield prediction output (such as by specifying desired filters in the request that is input to the agricultural computer system 116 for running the trained model).

At 214, the agricultural computer system 116 accesses a trained portfolio optimization model (which may be trained using methods similar to the seed placement prediction model 170, as described above), and data associated with one or more grower constraints. For example, the grower constraints may include parameters indicative of grower preferences when selecting seeds to plant, such as preferred seeding rates, preferred relative maturity spread and tolerance, preferred range or number of crop varieties, preferred minimum and maximum product volumes, preferred minimum and maximum trait mixes and tolerances, preferred minimum and maximum brand mixes and tolerances, preferred minimum and maximum acre fractions of newly launched products, preferred planting/harvest windows, etc. The grower constraints may be obtained in any suitable manner, such as inputs to the agricultural computer system 116 by the user 103 associated with the target growing space, current or previous survey responses from the user 103, or other growers in a same region, historical seed purchase data, historical seed planting data, etc.

In some example embodiments, the grower constraints may include raw data that may include grower profiles and/or input into the agricultural computer system 116, grower data including one or more data warehouses, product characteristic data including agronomic traits (standability, iron deficiency chlorosis, etc.), plant disease resistance, etc., and product supply data. The raw data may form product block lists, enrolled field information, and grower preference and operations management data. The enrolled field information may include location information (e.g., latitude and longitude, etc.), field productivity, pairwise distance information, adjacent field pairs information, and acre information. The grower preference and operations management data may include RM min, max, and weighted average data, information about a number of products, minimum boxes data, brand mix data, trait mix data, RM capacity data, seeding rate data, single product capacity data, launch product capacity data, planting/harvest window, and map data.

In some example embodiments, additional grower constraints may include planting and harvesting patterns such as field clusters. For example, a grower may prefer products with a similar maturity to be planted together (e.g., within the same field cluster). Alternatively, a grower may prefer to harvest one side of an operation first so the grower may plant crops or seed varieties with an earlier maturity on the side to be harvested first.

Next, the agricultural computer system 116 generates a seed planting recommendation using the portfolio optimization model 180, at 216, which is consistent with one or more of the objectives explained above with reference to FIG. 1 (e.g., operation-level weather risk based on a mean absolute deviation of predicted yield across historical weather year scenarios; to enhance operation-level acre-weighted mean yield; high performing products on high productivity fields, stable products on low productivity fields, agronomic trait/disease resistance optimization; and/or to limit spatial span metric; etc.). For example, the portfolio optimization model 180 may receive the yield prediction output array 213 from the seed placement prediction model 170 as an input, and receive one or more grower constraints as input, in order to generate a recommended portfolio of seeds for planting at the target growing space. For example, the recommended portfolio of seeds may be determined based on one or more objectives, associated with, for example, which candidate seeds have the highest expected yield (and optionally, a most desirable variance value for the yield predictions), subject to modification according to the grower constraints (e.g., a range of high predicted yield crop types and/or seed products may be selected consistent with a grower constraint to have at least three different varieties of crops planted, etc.).

Next, the agricultural computer system 116 directs, at 218, seeding of the target growing space based on the seed portfolio recommendation output from the trained portfolio optimization model 180. For example, the agricultural computer system 116 may direct seeding of the target growing space, at 218, for all crop types and/or seed products included in the seed recommendation portfolio.

Directing the seeding may include providing a seed portfolio recommendation output from the agricultural computer system 116 to a user 103, or other user or to the farm equipment 106, for example, as explained above, where the recommendation indicates which seeds should be planted in the target growing space, consistent with the predicted yields and grower constraints for the multiple candidate crop types and/or seed products. In various implementations, the seed portfolio recommendation output may include an indication of the recommended seed to plant, an indication of the predicted yield for given weather (e.g., organized into an interface, etc.), a recommended seed product to purchase, etc., or also binary indicators, YES or NO, or 1 or 0, etc., for each candidate seed product, whereby the one value indicates the candidate seed or purchased seed product should be planted in the growing space. In some example embodiments, supplementary information that may be output may include predicted yield information, predicted yield variations (e.g., how stable a yield is across different weather scenarios), agronomics/disease ratings, and information about data is behind different prediction values (e.g., a number of testing sites, win rates on the testing sites, etc.).

In response, the user 103 may select to accept the recommendation (e.g., via the CLIMATE FIELDVIEW application, etc.), whereby the recommended seed type is ordered consistent with the recommendation. In addition, the agricultural computer system 116 may generated and direct a script consistent with the recommendation, for operating the farm equipment 106, and deliver the script to the user 103 (e.g., via the CLIMATE FIELDVIEW application, etc.) and/or the farm equipment 106, etc. The farm equipment 106 may then be used to plant the growing space to plant one or more specified seed types, such as by placing seeds in the soil of the target growing space, etc., based on the script and/or the recommendation, etc.

With further reference to FIG. 1, the user 103 (e.g., a grower, a sales representative, another user, etc.) in the system 100 may own, operate or possess the communication device 104 (e.g., as a field manager computing device, etc.) in a growing location or associated with a growing location (e.g., one or more of the growing locations, etc.), such as a field intended for agricultural activities or a management location for one or more agricultural fields. The communication device 104 is programmed, or configured, to provide field data to the agricultural computer system 116 via one or more networks (as indicated by arrowed lines in FIG. 1) (e.g., for use in identifying characteristics of a target field of the growing spaces, etc.). Again, the network(s) may each include, without limitation, one or more of local area networks (LANs), wide area network (WANs) (e.g., the Internet, etc.), mobile/cellular networks, virtual networks, and/or another suitable public and/or private networks capable of supporting communication among parts of the system 100 illustrated in FIG. 1, or any combination thereof.

Examples of field data may include, for example, (a) identification data (for example, acreage, field name, field identifiers, geographic identifiers, boundary identifiers, crop identifiers, and any other suitable data that may be used to identify farm land, such as a common land unit (CLU), lot and block number, a parcel number, geographic coordinates and boundaries, Farm Serial Number (FSN), farm number, tract number, field number, section, township, and/or range), (b) harvest data (for example, crop type, crop variety, crop rotation, whether the crop is grown organically, harvest date, Actual Production History (APH), expected yield, yield, crop price, crop revenue, grain moisture, tillage practice, and previous growing season information), (c) soil data (for example, type, composition, pH, organic matter (OM), cation exchange capacity (CEC)), (d) planting data (for example, planting date, seed(s) type, relative maturity (RM) of planted seed(s), seed population), (e) fertilizer data (for example, nutrient type (Nitrogen, Phosphorous, Potassium), application type, application date, amount, source, method), (f) chemical application data (for example, pesticide, herbicide, fungicide, other substance or mixture of substances intended for use as a plant regulator, defoliant, or desiccant, application date, amount, source, method), (g) irrigation data (for example, application date, amount, source, method), (h) weather data (for example, precipitation, rainfall rate, predicted rainfall, water runoff rate region, temperature, wind, forecast, pressure, visibility, clouds, heat index, dew point, humidity, snow depth, air quality, sunrise, sunset), (i) imagery data (for example, imagery and light spectrum information from an agricultural apparatus sensor, camera, computer, smartphone, tablet, unmanned aerial vehicle, planes or satellite), (j) scouting observations (photos, videos, free form notes, voice recordings, voice transcriptions, weather conditions (temperature, precipitation (current and over time), soil moisture, crop growth stage, wind velocity, relative humidity, dew point, black layer)), (k) soil, seed, crop phenology, pest and disease reporting, and predictions sources and databases, and (l) other data described herein, etc.

As described, data server 108 is communicatively coupled to the agricultural computer system 116 and is programmed, or configured, to send external data (e.g., data associated with growing spaces, etc.) to agricultural computer system 116 via the network(s) herein (e.g., for use in identifying candidate seeds for the target field identified by the user 103, etc.). The data server 108 may be owned or operated by the same legal person or entity as the agricultural computer system 116, or by a different person or entity, such as a government agency, non-governmental organization (NGO), and/or a private data service provider. Examples of external data may include weather data, imagery data, soil data, seed data and treatment data as described herein, data from the various growing spaces herein, or statistical data relating to crop yields, among others. External data may include the same type of information as field data. In some embodiments, the external data may also be provided by data server 108 owned by the same entity that owns and/or operates the agricultural computer system 116. For example, the agricultural computer system 116 may include a data server focused exclusively on a type of data that might otherwise be obtained from third party sources, such as weather data to trial data. In some embodiments, data server 108 may be incorporated or integrated, in whole or in part, in the agricultural computer system 116.

The system 100 also includes, as described above, the farm equipment 106 configured to plant, treat or harvest crops from one or more growing spaces (e.g., from one or more of the growing spaces 102, etc.). In some examples, the farm equipment 106 may have one or more remote sensors fixed thereon, where the sensor(s) are communicatively coupled, either directly or indirectly, via the farm equipment 106 to the agricultural computer system 116 and are programmed, or configured, to send sensor data to agricultural computer system 116.

Additional examples of farm equipment 106 that may be included in the system 100 include tractors, combines, pickers, sprayers, planters, trucks, fertilizer equipment, aerial vehicles including unmanned aerial vehicles, and any other item of physical machinery or hardware, typically mobile machinery, and which may be used in tasks associated with agriculture and/or related to operations described herein. In some embodiments, a single unit of the farm equipment may comprise a plurality of sensors that are coupled locally in a network on the apparatus/equipment. A controller area network (CAN) is an example of such a network that can be installed in combines, harvesters, sprayers, and cultivators. In connection therewith, then, an application controller associated with the apparatus may be communicatively coupled to agricultural computer system 116 via the network(s) and programmed, or configured, to receive one or more scripts that are used to control an operating parameter of the farm equipment 106 (or another agricultural vehicle or implement) from the agricultural computer system 116. For instance, a controller area network (CAN) bus interface may be used to enable communications from the agricultural computer system 116 to the farm equipment 106, for example, such as through the CLIMATE FIELDVIEW DRIVE, available from Climate LLC, Saint Louis, Missouri, is used. Sensor data may consist of the same type of information as field data. In some embodiments, remote sensors may not be fixed to farm equipment but may be remotely located in the field and may communicate with one or more networks of the system 100.

As indicated above, the network(s) of the system 100 are generally illustrated in FIG. 1 by arrowed lines. In connection therewith, the network(s) broadly represent any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. For instance, the farm equipment 106 in the system 100, data server 108, agricultural computer system 116, and other elements of the system 100 may each comprise an interface compatible with the network(s) and programmed, or configured, to use standardized protocols for communication across the networks, such as TCP/IP, Bluetooth, CAN protocol and higher-layer protocols, such as HTTP, TLS, and the like.

Agricultural computer system 116 is programmed, or configured, generally, to receive field data from communication device 104, external data 120 from external data server 122, and sensor data from one or more remote sensors in the system 100. Agricultural computer system 116 may be further configured to host, use or execute one or more computer programs, other software elements, digitally programmed logic, such as FPGAs or ASICs, or any combination thereof, to perform translation and storage of data values, construction of digital models of one or more crops on one or more fields, generation of recommendations and notifications, and generation and sending of scripts, in the manner described further in other sections of this disclosure.

In an embodiment, agricultural computer system 116 is programmed with or comprises a communication layer 132, a presentation layer 134, a data management layer 140, a hardware/visualization layer 150, and a model and field data repository 160. “Layer,” in this context, refers to any combination of electronic digital interface circuits, microcontrollers, firmware, such as drivers, and/or computer programs, or other software elements.

Communication layer 132 may be programmed, or configured, to perform input/output interfacing functions including sending requests to communication device 104, data server 108, and remote sensor(s) for field data, external data, and sensor data respectively. Communication layer 132 may be programmed, or configured, to send the received data to model and field data repository 160 to be stored as field data (e.g., in agricultural computer system 116, etc.).

Presentation layer 134 may be programmed, or configured, to generate a graphical user interface (GUI) to be displayed on communication device 104 (e.g., to interact with agricultural computer system, to identify the target field(s), to select inputs, etc.), or other computers that are coupled to the agricultural computer system 116 through the network(s). The GUI may comprise controls for inputting data to be sent to agricultural computer system 116, generating requests for models and/or recommendations, and/or displaying recommendations, notifications, models, and other field data.

Data management layer 140 may be programmed, or configured, to manage read operations and write operations involving the field data repository 160 and other functional elements of the system, including queries and result sets communicated between the functional elements of the system and the repository. Examples of data management layer 140 include JDBC, SQL server interface code, and/or HADOOP interface code, among others. Field data repository 160 may comprise a database. As used herein, the term “database” may refer to either a body of data, a relational database management system (RDBMS), or both. As used herein, a database may comprise any collection of data including hierarchical databases, relational databases, flat file databases, object-relational databases, object oriented databases, distributed databases, and any other structured collection of records or data that is stored in a computer system. Examples of RDBMS's include, but are not limited to, ORACLE®, MYSQL, IBM® DB2, MICROSOFT® SQL SERVER, SYBASE®, and POSTGRESQL databases. That said, any database may be used that enables the systems and methods described herein.

When field data is not provided directly to the agricultural computer system 116 via farm equipment that interacts with the agricultural computer system 116, the user 103 may be prompted via one or more user interfaces on the communication device 104 (served by the agricultural computer system 116) to input such data to the agricultural computer system 116. In an example embodiment, the user 103 may specify identification data by accessing a map on the communication device 104 (served by the agricultural computer system 116) and selecting specific CLUs that have been graphically shown on the map. In an alternative embodiment, the user 103 may specify data by accessing a map on the communication device 104 (served by the agricultural computer system 116) and drawing boundaries of the field over the map to indicate specific data. Such CLU selection, or map drawings, represent geographic identifiers. In alternative embodiments, the user 103 may specify data by accessing field identification data (provided as shape files or in a similar format) from the U.S. Department of Agriculture Farm Service Agency, or other source, via the communication device 104 and providing such field identification data to the agricultural computer system 116.

In an example embodiment, the agricultural computer system 116 is programmed to generate and cause displaying of a graphical user interface comprising a data manager for data input. After one or more fields (or associated data) have been identified using the methods described above, the data manager may provide one or more graphical user interface widgets which when selected can identify changes to the field, soil, crops, tillage, or nutrient practices, and/or which may provide comparison data related to target seed identified by the user 103 and candidate seeds identified by the disclosure herein for fields of the growing spaces. The data manager may include a timeline view, a spreadsheet view, a graphical view, and/or one or more editable programs.

In an embodiment, model and field data is stored in model and field data repository 160. Model data comprises data models created for one or more fields. For example, a crop model may include a digitally constructed model of the development of a crop on the one or more fields. “Model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein may have a practical application in a computer in the form of stored executable instructions and data that implement the model using the computer. The model may include a model of past events on the one or more fields/plots, a model of the current status of the one or more fields/plots, and/or a model of predicted events on the one or more fields/plots. Model and field data may be stored in data structures in memory, rows in a database table, in flat files or spreadsheets, or other forms of stored digital data.

With reference again to FIG. 1, in an embodiment, instructions 135 of the agricultural computer system 116 may comprise a set of one or more pages of main memory, such as RAM, in the agricultural computer system 116 into which executable instructions have been loaded and which when executed cause the agricultural computer system 116 to perform the functions or operations that are described herein. For example, the instructions 135 may comprise a set of pages in RAM that contain instructions which, when executed, cause performing treatment decision functions described herein. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. The term “pages” is intended to refer broadly to any region within main memory and the specific terminology used in a system may vary depending on the memory architecture or processor architecture. In another embodiment, the instructions 135 also may represent one or more files, or projects of source code, that are digitally stored in a mass storage device, such as non-volatile RAM or disk storage, in the agricultural computer system 116 or a separate repository system, which when compiled or interpreted cause generating executable instructions which when executed cause the agricultural computer system 116 to perform the functions or operations that are described herein. In other words, the drawing figure may represent the manner in which programmers or software developers organize and arrange source code for later compilation into an executable, or interpretation into bytecode or the equivalent, for execution by the agricultural computer system 116.

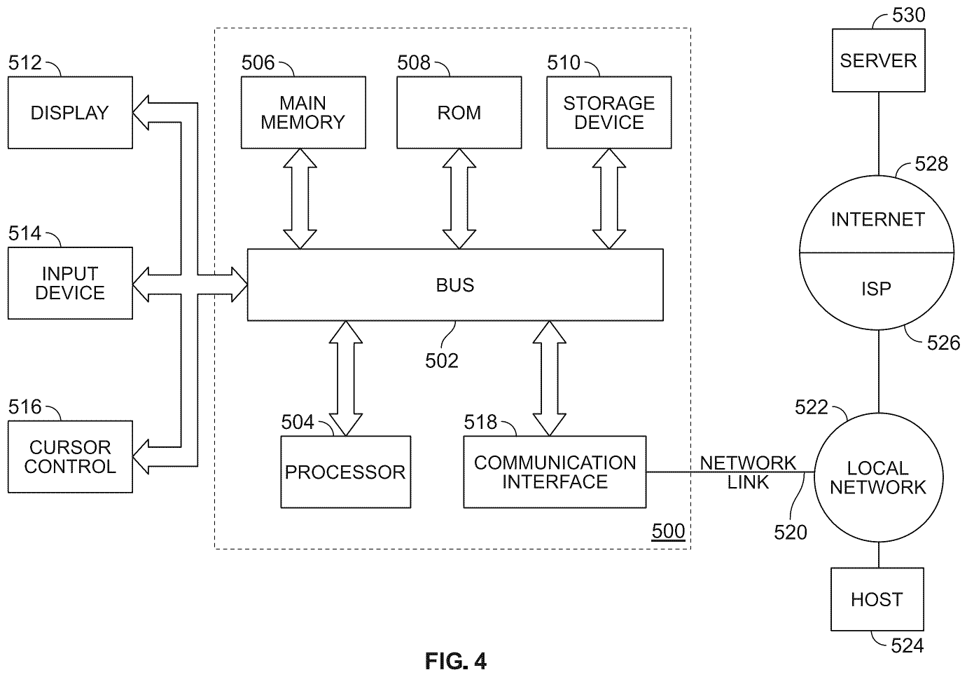

Hardware/visualization layer 150 comprises one or more central processing units (CPUs), memory controllers, and other devices, components, or elements of a computer system, such as volatile or non-volatile memory, non-volatile storage, such as disk, and I/O devices or interfaces as illustrated and described, for example, in connection with FIG. 4. The hardware/visualization layer 150 also may comprise programmed instructions that are configured to support visualization, virtualization, containerization, or other technologies.

For purposes of illustrating a clear example, FIG. 1 shows a limited number of instances of certain functional elements. However, in other embodiments, there may be any number of such elements. For example, embodiments may use thousands or millions of different mobile computing devices associated with different users/growers. Further, the agricultural computer system 116 and/or data server 108 may be implemented using two or more processors, cores, clusters, or instances of physical machines or virtual machines, configured in a discrete location or co-located with other elements in a datacenter, shared computing facility or cloud computing facility.

In an embodiment, the implementation of the functions described herein using one or more computer programs, or other software elements that are loaded into and executed using one or more general-purpose computers, will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans or directions that may be used to program a computer or logic to implement the functions that are described. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for disclosures of this type.

In an embodiment, user 103 interacts with agricultural computer system 116 using communication device 104 configured with an operating system and one or more application programs or apps. The communication device 104 also may interoperate with the agricultural computer system 116 independently and automatically under program control or logical control and direct user interaction is not always required. The communication device 104 broadly represents one or more of a smart phone, PDA, tablet computing device, laptop computer, desktop computer, workstation, or any other computing device capable of transmitting and receiving information and performing the functions described herein. The communication device 104 may communicate via a network using a mobile application stored on the communication device 104, and in some embodiments, the communication device 104 may be coupled using a cable or connector to one or more sensors and/or other apparatus in the system 100. A particular user 103 may own, operate or possess and use, in connection with system 100, more than one communication device at a time.

The mobile application associated with the communication device 104 may provide client-side functionality, via the network to one or more mobile computing devices. In an example embodiment, the communication device 104 may access the mobile application via a web browser or a local client application or app. The communication device 104 may transmit data to, and receive data from, one or more front-end servers, using web-based protocols, or formats, such as HTTP, XML and/or JSON, or app-specific protocols. In an example embodiment, the data may take the form of requests (e.g., for a decision, selection, etc.) and user information input, such as field data, into the mobile computing device. In some embodiments, the mobile application interacts with location tracking hardware and software on the communication device 104 which determines the location of the communication device 104 using standard tracking techniques, such as radio signals, the global positioning system (GPS), Wi-Fi positioning systems, or other methods of mobile positioning. In some cases, location data or other data associated with the communication device 104, user 103, and/or user account(s) may be obtained by queries to an operating system of the device or by requesting an app on the device to obtain data from the operating system.

In an embodiment, in addition to other functionalities described herein, the communication device 104 sends field data to agricultural computer system 116 comprising or including, but not limited to, data values representing one or more of: a geographical location of the one or more fields, tillage information for the one or more fields, crops planted in the one or more fields, and soil data extracted from the one or more fields. The communication device 104 may send field data in response to user input from user 103 specifying the data values for the one or more fields. Additionally, the communication device 104 may automatically send field data when one or more of the data values becomes available to the communication device 104. For example, the communication device 104 may be communicatively coupled to a remote sensor in the system 100, and in response to an input received at the sensor, the communication device 104 may send field data to agricultural computer system 116 representative of the input. Field data identified in this disclosure may be input and communicated using electronic digital data that is communicated between computing devices using parameterized URLs over HTTP, or another suitable communication or messaging protocol. In that sense, in some aspects of the present disclosure, the field data provided by the communication device 104 may also be stored as external data (e.g., where the field data is collected as part of harvesting crops from growing spaces, etc.), for example, in data server 108.

A commercial example of the mobile application is CLIMATE FIELDVIEW, commercially available from Climate LLC, Saint Louis, Missouri. The CLIMATE FIELDVIEW application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it combines historical data about the grower's fields with any other data that the grower wishes to compare. The combinations and comparisons may be performed in real time and are based upon scientific models that provide potential scenarios to permit the grower to make better, more informed decisions.

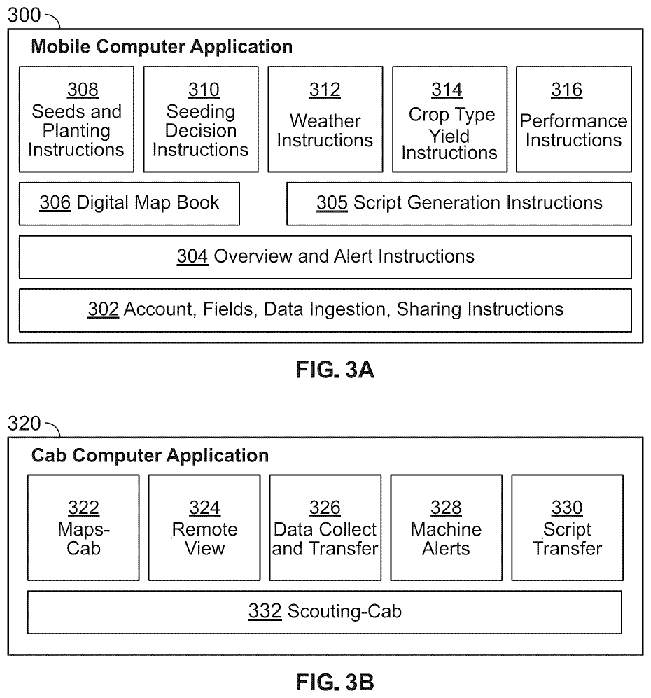

FIGS. 3A-3B illustrate two views of an example logical organization of sets of instructions in main memory when an example mobile application is loaded for execution. Each named element represents a region of one or more pages of RAM, or other main memory, or one or more blocks of disk storage, or other non-volatile storage, and the programmed instructions within those regions. In one embodiment, in FIG. 3A, a mobile computer application 300 comprises account-fields-data ingestion-sharing instructions 302, overview and alert instructions 304, digital map book instructions 306, seeds and planting instructions 308, seeding decision instructions 310, weather instructions 312, crop type yield instructions 314, and performance instructions 316.

In one embodiment, a mobile computer application 300 comprises account, fields, data ingestion, sharing instructions 302 which are programmed to receive, translate, and ingest field data from third party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 300 comprises a data inbox. In response to receiving a selection of the data inbox, the mobile computer application 300 may display a graphical user interface for manually uploading data files and importing uploaded files to a data manager.

In one embodiment, digital map book instructions 306 comprise field map data layers stored in device memory and are programmed with data visualization tools and geospatial field notes. This provides growers with convenient information close at hand for reference, logging and visual insights into field performance. In one embodiment, overview and alert instructions 304 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 308 are programmed to provide tools for seed selection, hybrid placement, and script creation, including variable rate (VR) script creation, based upon scientific models and empirical data. This enables growers to maximize yield, or return on investment, through optimized seed purchase, placement and population.

In one embodiment, script generation instructions 305 are programmed to provide an interface for generating scripts, including variable rate (VR) fertility scripts. The interface enables growers to create scripts for field implements, such as treatment decisions, planting, and irrigation. For example, a planting script interface may comprise tools for identifying a type of seed for planting. Upon receiving a selection of the seed type, mobile computer application 300 may display one or more fields broken into management zones, such as the field map data layers created as part of digital map book instructions 306. In one embodiment, the management zones comprise soil zones along with a panel identifying each soil zone and a soil name, texture, drainage for each zone, or other field data. Mobile computer application 300 may also display tools for editing or creating such as graphical tools for drawing management zones, such as soil zones, over a map of one or more fields. Planting procedures may be applied to all management zones or different planting procedures may be applied to different subsets of management zones. When a script is created, mobile computer application 300 may make the script available for download in a format readable by an application controller, such as an archived or compressed format. Additionally, and/or alternatively, a script may be sent directly to a cab computer (e.g., associated with farm equipment 106, etc.) from mobile computer application 300 and/or uploaded to one or more data servers and stored for further use.

In one embodiment, seeding decision instructions 310 are programmed to provide tools to inform decisions by visualizing or instruction about the application of one or more candidate seed types for planting in a particular field. This enables growers to potentially enhance yield or return on investment through higher crop yield during the season.

Example programmed functions include displaying images to enable tuning application of seeds across multiple zones; output of scripts to drive machinery; tools for mass data entry and adjustment; and/or maps for data visualization, among others. Seeding decision instructions 310 also may be programmed to generate and cause displaying a seeding graph, indicative of the application of the seeds to one or more target fields, but not other based on the functions explained herein. In one embodiment, the seeding graph may include one or more user input features, such as dials or slider bars, to dynamically change the candidate seeding programs so that the grower may alter the parameters of the seeding decision. Seeding decision instructions 310 also may be programmed to generate and cause displaying a seeding decision or indications.

In one embodiment, weather instructions 312 are programmed to provide field-specific recent weather data and forecasted weather information. This enables growers to save time and have an efficient integrated display with respect to daily operational decisions.

In one embodiment, crop type yield instructions 314 are programmed to provide timely remote sensing images highlighting in-season crop variation, multiple crop types and potential concerns. Example programmed functions include cloud checking, to identify possible clouds or cloud shadows; determining seeding indices based on field images; graphical visualization of scouting layers, including, for example, those related to field health, and viewing and/or sharing of scouting notes; recording observations of different crop type performance; and/or downloading satellite images from multiple sources and prioritizing the images for the grower, among others.

In one embodiment, performance instructions 316 are programmed to provide reports, analysis, and insight tools using on-farm data for evaluation, insights and decisions. This enables the grower to seek improved outcomes for the next year through fact-based conclusions about why return on investment was at prior levels, and insight into yield-limiting factors. The performance instructions 316 may be programmed to communicate via the network(s) to back-end analytics programs executed at agricultural computer system 116 and/or data server 108 and configured to analyze metrics, such as yield, yield differential, hybrid, population, SSURGO zone, soil test properties, or elevation, among others. Programmed reports and analysis may include yield variability analysis, treatment effect estimation, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers, or smartphones, may provide a full app experience, or a cab app experience, that is suitable for the display and processing capabilities of a cab computer (e.g., associated with farm equipment 106, etc.). For example, referring now to FIG. 3B, in one embodiment a cab computer application 320 (e.g., as accessible in farm equipment 106, etc.) may comprise maps-cab instructions 322, remote view instructions 324, data collect and transfer instructions 326, machine alerts instructions 328, script transfer instructions 330, and scouting-cab instructions 332. The code base for the instructions of FIG. 3B may be the same as for FIG. 3A and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 322 may be programmed to provide map views of fields, farms or regions that are useful in directing machine operation. The remote view instructions 324 may be programmed to turn on, manage, and provide views of machine activity in real-time or near real-time to other computing devices connected to the agricultural computer system 116 via wireless networks, wired connectors or adapters, and the like. The data collect and transfer instructions 326 may be programmed to turn on, manage, and provide transfer of data collected at sensors and controllers to the agricultural computer system 116 via wireless networks, wired connectors or adapters, and the like (e.g., via network(s) in the system 100, etc.). The machine alerts instructions 328 may be programmed to detect issues with operations of the machine or tools that are associated with the cab and generate operator alerts. The script transfer instructions 330 may be configured to transfer in scripts of instructions that are configured to direct machine operations or the collection of data. The scouting-cab instructions 332 may be programmed to display location-based alerts and information received from the agricultural computer system 116 based on the location of the communication device 104, farm equipment 106, or sensors in the field (of the growing spaces) and ingest, manage, and provide transfer of location-based scouting observations to the agricultural computer system 116 based on the location of the farm equipment 106, or sensors in the field.

In an embodiment, data server 108 stores external data 120 from the external data server 122, including soil data representing soil composition for the one or more fields and weather data representing temperature and precipitation on the one or more fields. The weather data may include past and present weather data as well as forecasts for future weather data. In an embodiment, data server 108 comprises a plurality of servers hosted by different entities. For example, a first server may contain soil composition data while a second server may include weather data. Additionally, soil composition data may be stored in multiple servers. For example, one server may store data representing percentage of sand, silt, and clay in the soil while a second server may store data representing percentage of organic matter (OM) in the soil. Further, in some embodiments, the data server 108, again, may include data associated with the growing spaces with regard to available seeds for use in comparisons, etc.

In an embodiment, remote sensors in the system 100 may comprise one or more sensors that are programmed, or configured, to produce one or more observations related to growing spaces, trials therein, etc. Remote sensors may be aerial sensors, such as satellites, vehicle sensors, planting equipment sensors, tillage sensors, fertilizer or insecticide application sensors, harvester sensors, and any other implement capable of receiving data from the one or more fields (e.g., associated with one or more of the growing spaces, etc.). In an embodiment, farm equipment 106 may include an application controller programmed, or configured, to receive instructions from agricultural computer system 116. The application controller may also be programmed, or configured, to control an operating parameter of the farm equipment 106. Other embodiments may use any combination of sensors and controllers, of which the following are merely selected examples.

The system 100 may obtain or ingest data under grower control, on a mass basis from a large number of growers who have contributed trial data or other data to a shared database system. This form of obtaining data may be termed “manual data ingest” as one or more user-controlled computer operations are requested, or triggered, to obtain data for use by the agricultural computer system 116. As an example, the CLIMATE FIELDVIEW application, commercially available from Climate LLC, Saint Louis, Missouri, may be operated to export data to agricultural computer system 116 for storing in the field data repository 160.

For example, seed monitor systems can both control planter apparatus components and obtain planting data, including signals from seed sensors via a signal harness that comprises a CAN backbone and point-to-point connections for registration and/or diagnostics. Seed monitor systems can be programmed, or configured, to display seed spacing, population and other information to the user via a cab computer of the apparatus, or other devices within the system 100.

Likewise, yield monitor systems may contain yield sensors for harvester apparatus that send yield measurement data to a cab computer of the apparatus, or other devices within the system 100. Yield monitor systems may utilize one or more remote sensors to obtain grain moisture measurements in a combine, or other harvester, and transmit these measurements to the user 103 via the cab computer, or other devices within the system 100.

In an embodiment, examples of sensors that may be used with any moving vehicle, or apparatus of the type described elsewhere herein, include kinematic sensors and position sensors. Kinematic sensors may comprise any of speed sensors, such as radar or wheel speed sensors, accelerometers, or gyros. Position sensors may comprise GPS receivers or transceivers, or WiFi-based position or mapping apps that are programmed to determine location based upon nearby WiFi hotspots, among others.

In an embodiment, examples of sensors that may be used with tractors, or other moving vehicles, include engine speed sensors, fuel consumption sensors, area counters or distance counters that interact with GPS or radar signals, PTO (power take-off) speed sensors, tractor hydraulics sensors configured to detect hydraulics parameters, such as pressure or flow, and/or and hydraulic pump speed, wheel speed sensors or wheel slippage sensors. In an embodiment, examples of controllers that may be used with tractors include hydraulic directional controllers, pressure controllers, and/or flow controllers; hydraulic pump speed controllers; speed controllers or governors; hitch position controllers; or wheel position controllers provide automatic steering.

In an embodiment, examples of sensors that may be used with seed planting equipment, such as planters, drills, or air seeders, include seed sensors, which may be optical, electromagnetic, or impact sensors; downforce sensors, such as load pins, load cells, pressure sensors; soil property sensors, such as reflectivity sensors, moisture sensors, electrical conductivity sensors, optical residue sensors, or temperature sensors; component operating criteria sensors, such as planting depth sensors, downforce cylinder pressure sensors, seed disc speed sensors, seed drive motor encoders, seed conveyor system speed sensors, or vacuum level sensors; or pesticide application sensors, such as optical or other electromagnetic sensors, or impact sensors. In an embodiment, examples of controllers that may be used with such seed planting equipment include: toolbar fold controllers, such as controllers for valves associated with hydraulic cylinders; downforce controllers, such as controllers for valves associated with pneumatic cylinders, airbags, or hydraulic cylinders, and programmed for applying downforce to individual row units or an entire planter frame; planting depth controllers, such as linear actuators; metering controllers, such as electric seed meter drive motors, hydraulic seed meter drive motors, or swath control clutches; hybrid selection controllers, such as seed meter drive motors, or other actuators programmed for selectively allowing or preventing seed or an air-seed mixture from delivering seed to or from seed meters or central bulk hoppers; metering controllers, such as electric seed meter drive motors, or hydraulic seed meter drive motors; seed conveyor system controllers, such as controllers for a belt seed delivery conveyor motor; marker controllers, such as a controller for a pneumatic or hydraulic actuator; or pesticide application rate controllers, such as metering drive controllers, orifice size or position controllers.

In an embodiment, examples of sensors that may be used with tillage equipment include position sensors for tools, such as shanks or discs; tool position sensors for such tools that are configured to detect depth, gang angle, or lateral spacing; downforce sensors; or draft force sensors. In an embodiment, examples of controllers that may be used with tillage equipment include downforce controllers or tool position controllers, such as controllers configured to control tool depth, gang angle, or lateral spacing.

In an embodiment, examples of sensors that may be used in relation to an apparatus for applying fertilizer, insecticide, fungicide and the like, such as on-planter starter fertilizer systems, subsoil fertilizer applicators, or fertilizer sprayers, include: fluid system criteria sensors, such as flow sensors or pressure sensors; sensors indicating which spray head valves or fluid line valves are open; sensors associated with tanks, such as fill level sensors; sectional or system-wide supply line sensors, or row-specific supply line sensors; or kinematic sensors, such as accelerometers disposed on sprayer booms. In an embodiment, examples of controllers that may be used with such apparatus include pump speed controllers; valve controllers that are programmed to control pressure, flow, direction, PWM and the like; or position actuators, such as for boom height, subsoiler depth, or boom position.

In an embodiment, examples of sensors that may be used with harvesters include yield monitors, such as impact plate strain gauges or position sensors, capacitive flow sensors, load sensors, weight sensors, or torque sensors associated with elevators or augers, or optical or other electromagnetic grain height sensors; grain moisture sensors, such as capacitive sensors; grain loss sensors, including impact, optical, or capacitive sensors; header operating criteria sensors, such as header height, header type, deck plate gap, feeder speed, and reel speed sensors; separator operating criteria sensors, such as concave clearance, rotor speed, shoe clearance, or chaffer clearance sensors; auger sensors for position, operation, or speed; or engine speed sensors. In an embodiment, examples of controllers that may be used with harvesters include header operating criteria controllers for elements, such as header height, header type, deck plate gap, feeder speed, or reel speed; separator operating criteria controllers for features such as concave clearance, rotor speed, shoe clearance, or chaffer clearance; or controllers for auger position, operation, or speed.

In an embodiment, examples of sensors that may be used with grain carts include weight sensors, or sensors for auger position, operation, or speed. In an embodiment, examples of controllers that may be used with grain carts include controllers for auger position, operation, or speed.

In an embodiment, examples of sensors and controllers may be installed in unmanned aerial vehicle (UAV) apparatus or “drones.” Such sensors may include cameras with detectors effective for any range of the electromagnetic spectrum including visible light, infrared, ultraviolet, near-infrared (NIR), and the like; accelerometers; altimeters; temperature sensors; humidity sensors; pitot tube sensors or other airspeed or wind velocity sensors; battery life sensors; or radar emitters and reflected radar energy detection apparatus; other electromagnetic radiation emitters and reflected electromagnetic radiation detection apparatus. Such controllers may include guidance or motor control apparatus, control surface controllers, camera controllers, or controllers programmed to turn on, operate, obtain data from, manage and configure any of the foregoing sensors.

In an embodiment, sensors and controllers may be affixed to a soil sampling and measurement apparatus that is configured, or programmed, to sample soil and perform soil chemistry tests, soil moisture tests, and other tests pertaining to soil.

In an embodiment, sensors and controllers may comprise weather devices for monitoring weather conditions of fields.

In an embodiment, the agricultural computer system 116 is programmed, or configured, to create an agronomic model. In this context, an agronomic model is a data structure in memory of the agricultural computer system 116 that comprises field data, such as identification data and harvest data for one or more fields. The agronomic model may also comprise calculated agronomic properties which describes either conditions which may affect the growth of one or more crops on a field, or properties of the one or more crops, or both. Additionally, an agronomic model may comprise recommendations based on agronomic factors, such as crop recommendations, irrigation recommendations, planting recommendations, fertilizer recommendations, fungicide recommendations, pesticide recommendations, harvesting recommendations and other crop management recommendations. The agronomic factors may also be used to estimate one or more crop related results, such as agronomic yield. The agronomic yield of a crop is an estimate of quantity of the crop that is produced, or in some examples, the revenue or profit obtained from the produced crop.

In an embodiment, the agricultural computer system 116 may use a preconfigured agronomic model to calculate agronomic properties related to currently received location and crop information for one or more fields. The preconfigured agronomic model is based upon previously processed field data, including but not limited to, identification data, harvest data, fertilizer data, and weather data. The preconfigured agronomic model may have been cross validated to ensure accuracy of the model. Cross validation may include comparison to ground truthing that compares predicted results with actual results on a field, such as a comparison of precipitation estimate with a rain gauge or sensor providing weather data at the same or nearby location.

According to one example embodiment, the techniques described herein are implemented by one or more special-purpose computing devices. The special-purpose computing devices may be hard-wired to perform the techniques, or may include digital electronic devices, such as one or more application-specific integrated circuits (ASICs) or field programmable gate arrays (FPGAs), that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be a desktop computer systems, portable computer systems, handheld devices, networking devices or any other device that incorporates hard-wired and/or program logic to implement the techniques.

For example, FIG. 4 is a block diagram that illustrates a computer system 500 upon which embodiments of the present disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508, or other static storage device coupled to bus 502, for storing static information and instructions for processor 504. A storage device 510, such as a magnetic disk, optical disk, or solid-state drive, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes; a first axis (e.g., x, etc.) and a second axis (e.g., y, etc.), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of, or in combination with, software instructions.

The term “storage media” as used herein refers to any non-transitory media that stores data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from, but may be used in conjunction with, transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infrared data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infrared signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving a request for a planting recommendation related to seeding of a target growing space, the request including seed product data and location data relating to the target growing space, the seed product data including multiple identifiers each associated with a different one of multiple seed products available for planting at the target growing space; (b) accessing a seed placement prediction model consistent with the location data; (c) determining, using the seed placement prediction model, a prediction output, based at least on the location data and on weather data, the prediction output including a predicted yield for the multiple seed products at each of one or more different weather conditions; (d) accessing an optimization model consistent with the target growing space; (e) determining, using the optimization model, a seed planting recommendation output, based on at least the prediction output and at least one grower constraint parameter associated with the target growing space, the seed planting recommendation output including at least one of the multiple seed products; (f) directing planting of the at least one of the multiple seed products at the target growing space, based on the seed planting recommendation output; and/or (g) training the seed placement prediction model, based on historical data associated with multiple growing spaces and a set of multiple seed products.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for directing seed products to growing spaces, the computer-implemented method comprising:
receiving, by a computing device, a request for a planting recommendation related to seeding of a target growing space, the request including seed product data and location data relating to the target growing space, the seed product data including multiple identifiers each associated with a different one of multiple seed products available for planting at the target growing space;
accessing, by the computing device, one or more seed placement prediction models consistent with the location data;
determining, by the computing device, using the one or more seed placement prediction models, a prediction output, based, at least, on the location data and on weather data, the prediction output including a predicted yield for the multiple seed products at each of one or more different weather conditions, seed densities, and/or planting dates;
accessing, by the computing device, an optimization model consistent with the target growing space;
determining, by the computing device, using the optimization model, a seed planting recommendation output, based on at least the prediction output and at least one grower constraint parameter associated with the target growing space, the seed planting recommendation output including at least one of the multiple seed products; and
directing, by the computing device, planting of the at least one of the multiple seed products at the target growing space, based on the seed planting recommendation output.

2. The computer-implemented method of claim 1, further comprising training the one or more seed placement prediction models, based on historical data associated with multiple growing spaces and a set of multiple seed products.

3. The computer-implemented method of claim 2, wherein the set of multiple seed products includes the multiple seed products.

4. The computer-implemented method of claim 2, wherein inputs for training the one or more seed placement prediction models include, for each of the multiple growing spaces:
a location of the growing space; and
a yield of one or more of the multiple seed products at the growing space.

5. The computer-implemented method of claim 4, wherein the inputs for training the one or more seed placement prediction models include, for each of the multiple growing spaces, at least one of soil data of the growing space, weather data associated with the growing space, and hybrid/genetic seed data associated with seed products planted in the growing space.

6. The computer-implemented method of claim 1, further comprising training the optimization model, based on historical seed portfolio data associated with multiple growing spaces and multiple seed product types.

7. The computer-implemented method of claim 6, wherein inputs for training the optimization model include, for each of the multiple growing spaces:
a location of the growing space; and
a yield of a portfolio including at least two of the multiple seed product types at the growing space.

8. The computer-implemented method of claim 7, wherein the inputs for training the optimization model include, for each of the multiple growing spaces, at least one of field information of the growing space, available seed supply list information associated with the growing space, weather information associated with the growing space, and grower constraint information associated with the growing space.

9. The computer-implemented method of claim 8, wherein the grower constraint information includes at least one of a grower seeding rate preference, a grower relative maturity spread preference, a preferred range of different varieties, a minimum and maximum product volume preference, a trait mix preference, and a brand mix preference.

10. The computer-implemented method of claim 1, wherein:
determining, by the computing device, using the one or more seed placement prediction models, the prediction output includes generating a three-dimensional matrix output of yield predictions, the three dimensions of the matrix output including seed type, weather condition(s), and predicted yield.

11. The computer-implemented method of claim 1, wherein the one or more seed placement prediction models include a multilayer perceptron neural network and/or an XGBoost model.

12. The computer-implemented method of claim 1, wherein the seed planting recommendation output includes a portfolio having more than one of the multiple seed product types available for planting at the target growing space.

13. The computer-implemented method of claim 1, further comprising seeding the target growing space in response to the seed planting recommendation output.

14. The computer-implemented method of claim 13, further comprising:
receiving, at a communication device of a user associated with the target growing space, the seed planting recommendation output; and
causing operation of one or more agricultural apparatuses at the target growing space to apply the at least one of the multiple seed products to the target growing space.

15. A system for use in directing seed products to growing spaces, the system comprising at least one computing device configured to:
receive a request for a planting recommendation related to seeding of a target growing space, the request including seed product data and location data relating to the target growing space, the seed product data including multiple identifiers each associated with a different one of multiple seed products available for planting at the target growing space;
access one or more seed placement prediction models consistent with the location data;
determine, using the one or more seed placement prediction models, a prediction output, based, at least, on the location data and on weather data, the prediction output including a predicted yield for the multiple seed products at each of one or more different weather conditions, seed densities, and/or planting dates;
access an optimization model consistent with the target growing space;
determine, using the optimization model, a seed planting recommendation output, based on at least the prediction output and at least one grower constraint parameter associated with the target growing space, the seed planting recommendation output including at least one of the multiple seed products; and
direct planting of the at least one of the multiple seed products at the target growing space, based on the seed planting recommendation output.

16. The system of claim 15, wherein the at least one computing device is further configured to train the one or more seed placement prediction models, based on historical data associated with multiple growing spaces and a set of multiple seed products.

17. The system of claim 16, wherein the set of multiple seed products includes the multiple seed products; and
wherein inputs for training the one or more seed placement prediction models include, for each of the multiple growing spaces:
a location of the growing space; and
a yield of one or more of the multiple seed products at the growing space.

18. The system of claim 17, wherein the inputs for training the one or more seed placement prediction models include, for each of the multiple growing spaces, at least one of soil data of the growing space, weather data associated with the growing space, and hybrid/genetic seed data associated with seed products planted in the growing space.

19. The system of any one of claim 15, wherein the at least one computing device is further configured to train the optimization model, based on historical seed portfolio data associated with multiple growing spaces and multiple seed product types; and
wherein inputs for training the optimization model include, for each of the multiple growing spaces:
a location of the growing space; and
a yield of a portfolio including at least two of the multiple seed product types at the growing space.

20. The system of any claim 15, wherein the at least one computing device is configured, in order to determine the prediction output, to generate a three-dimensional matrix output of yield predictions, the three dimensions of the matrix output including seed type, weather condition(s), and predicted yield.

21. The system of claim 15, further comprising an agricultural apparatus configured to plant the at least one of the multiple seed products at the target growing space; and
wherein the agricultural apparatus is configured to receive the seed planting recommendation output from the at least one computing device and plant the at least one of the multiple seed products at the target growing space in response to the seed planting recommendation output.

22. The system of claim 21, further comprising a communication device associated with the user, the communication device configured to receive the seed planting recommendation output from the at least one computing device, and whereby the agricultural apparatus is configured to plant the at least one of the multiple seed products at the target growing space in response to the seed planting recommendation.
